(19) United States
(12) Patent Application Publication
(10) Pub. No.: US 2017/0298205 A1
(43) Pub. Date: Oct. 19, 2017

(54) POLYMER MICROPARTICLES AND METHOD FOR PRODUCING SAME

(71) Applicant: TOAGOSEI CO. LTD., Tokyo (JP)

(72) Inventors: Naohiko SAITO, Nagoya-shi (JP); Norihiro HIRANO, Nagoya-shi (JP); Hideo MATSUZAKI, Nagoya-shi (JP)

(73) Assignee: TOAGOSEI CO. LTD., Tokyo (JP)

(21) Appl. No.: 15/511,978

(22) PCT Filed: Sep. 16, 2015
(86) PCT No.: PCT/JP2015/076317

§ 371 Date: Mar. 16, 2017

(30) Foreign Application Priority Data
Sep. 18, 2014 (JP) 2014-189857

(51) Int. Cl. C08J 9/28

(52) U.S. Cl. CPC C08J 9/286; C08J 2333/02; C08J 2333/08

(57) ABSTRACT

The present disclosure relates to a method for producing polymer microparticles, this method including a step for polymerizing vinyl monomers in a hydrophilic solvent, which dissolves the vinyl monomers and a dispersion stabilizer but does not dissolve a polymer formed, in the presence of the dispersion stabilizer. The present disclosure is a method for producing these polymer microparticles, wherein the dispersion stabilizer contains a macromonomer having carboxyl groups and ethylenically unsaturated groups at an intermediate location in a molecular chain thereof, the macromonomer has, on average, 1.4 to 2.5 ethylenically unsaturated groups per molecule, and an average value of a carboxyl group content in the macromonomer is 0.5 meq/g to 2.5 meq/g.

### CROSS REFERENCE TO RELATED APPLICATIONS

This application is a related application of Japanese Patent Application No. 2014-189857 which is a Japanese patent application filed on Sep. 18, 2014, and claims priority based on this Japanese application, and all contents described in this Japanese application are incorporated herein by reference.

### TECHNICAL FIELD

The present invention relates to, for example, a method for producing polymer microparticles. More particularly, the present invention relates to, for example, a method for smoothly producing micron-sized polymer microparticles with favorable productivity that have a narrow particle size distribution and uniform particle diameter according to a dispersion polymerization method by using a specific dispersion stabilizer.

### BACKGROUND ART

According to dispersion polymerization, in which a polymer is produced by polymerizing vinyl monomers in a solvent, which dissolves the vinyl monomers but does not substantially dissolve the polymer formed, in the presence of a dispersion stabilizer, micron-sized polymer microparticles are known to be obtained that have a comparatively narrow particle size distribution.

In dispersion polymerization, a hydrophilic solvent or non-hydrophilic solvent is used for the polymerization solvent. When carrying out dispersion polymerization in a hydrophilic solvent, a high molecular weight dispersion stabilizer such as polyvinyl pyrrolidone, polyethylene glycol or polyacrylic acid is conventionally used for the dispersion stabilizer. In addition, a dispersion polymerization method is also known that uses a macromonomer having a radical polymerizable functional group on the end of a polyethylene oxide chain as a dispersion stabilizer (Patent Literature 1).

However, in the above-mentioned dispersion polymerization technology, it is necessary to use a comparatively large amount of dispersion stabilizer to produce polymer microparticles having a target particle diameter and particle size distribution. In addition, a large amount of dispersion stabilizer remains in the resulting polymer microparticles, easily having a detrimental effect on the performance of the polymer microparticles. Moreover, since dispersion stabilization of the dispersion stabilizer is inadequate, there is increased susceptibility to the occurrence of aggregation among the resulting polymer microparticles. Moreover, in the dispersion polymerization technology of the prior art as described above, it is necessary to carry out polymerization by lowering the concentration of vinyl monomers in order to prevent aggregation of the polymer microparticles formed by polymerization, thereby resulting in low productivity.

The inventors of the present invention disclosed a dispersion stabilizer effective for preventing aggregation during polymerization in the form of a macromonomer having carboxyl groups and unsaturated vinylidene-type bonds on the end of the polymer (Patent Literature 2). Moreover, the inventors of the present invention further disclosed a dispersion stabilizer effective for smooth dispersion polymerization in the form of a dispersion stabilizer containing a macromonomer having carboxyl groups and ethylenically unsaturated groups at an intermediate location in the molecular chain (Patent Literature 3), and a macromonomer having (meth)acryloyl groups on the end of the molecular chain and carboxyl groups at an intermediate location in the molecular chain (Patent Literature 4).

### CITATION LIST

### Patent Literature

[Patent Literature 1] Japanese Unexamined Patent Publication No. H9-157307

### [Patent Literature 2] Japanese Patent Application Laid-Open No. 2004-149569

### [Patent Literature 3] International Publication No. 2010/047287

### [Patent Literature 4] International Publication No. 2010/047305

### SUMMARY

Micron-sized polymer microparticles having a narrow particle size distribution and uniform particle diameter are used in applications such as light diffusing agents, anti-glare agents (matting agents), anti-blocking agents or spacers, and have recently been required to accommodate demands for high definition in the above-mentioned applications. Accordingly, there is a growing number of cases in which polymer microparticles are required that have a smaller particle diameter. In the case of using the dispersion stabilizer (macromonomer) described in Patent Literature 2, the particle diameter of the resulting polymer microparticles tends to be larger than 2 μm to 3 μm, it becomes necessary to increase the amount of dispersion stabilizer (macromonomer) used to obtain polymer microparticlcs having a smaller particle diameter, and it was determined that there is room for improvement with respect to, for example, preventing decreases in performance of the resulting polymer microparticles and suppressing increases in costs.

In addition, the dispersion stabilizers described in Patent Literature 3 and 4 demonstrate superior dispersion stabilizing effects in a dispersion polymerization reaction carried out in a hydrophilic solvent, and enable the stable production of polymer microparticles having small particle diameter and narrow particle size distribution despite using only a small amount of dispersion stabilizer.

However, when studies were conducted on polymerization under conditions of a higher monomer concentration for the purpose of further improving productivity or the like, it was determined that polymerization tends to become unstable under conditions of a high monomer concentration in excess of 20% by weight.

In an attempt to avoid this problem, the present invention provides a method for smoothly producing high-quality polymer microparticles having a narrow particle size distribution and small, uniform average particle diameter of about 2 μm to 3 μm or less even under conditions of a high monomer concentration during polymerization and without causing aggregation of the polymer microparticles and the like.

Moreover, an object of the present invention is to provide a method for smoothly producing high-quality, fine polymer microparticles with favorable productivity that smoothly demonstrate superior monodispersivity at low cost while preventing detrimental effects on the polymer microparticles attributable to the use of a large amount of dispersion stabilizer.

In addition, an object of the present invention is to provide polymer microparticles and the like that have the superior characteristics described above by dispersion polymerization.

Moreover, an object of the present invention is to provide a dispersion stabilizer preferable for producing these polymer microparticles and the use thereof.

As a result of conducting extensive studies to solve the above-mentioned problems, the inventors of the present invention found that, in the case of using a macromonomer having carboxyl groups and ethylenically unsaturated groups at an intermediate location in the molecular chain and having a specific acid value and number of ethylenically unsaturated groups as a dispersion stabilizer, polymer microparticles having a narrow particle size distribution and uniform size can be smoothly produced without causing aggregation and so forth among the polymer microparticles even under conditions of a high monomer concentration. In addition, the inventors of the present invention found that, in this case, since only an extremely small amount of the macromonomer is used as a dispersion stabilizer, it is not necessary to remove excess dispersion stabilizer by washing and the like and polymer microparticles having superior properties and handling ease can be produced with higher productivity and at lower cost, thereby leading to completion of the present invention on the basis of these findings.

The present teachings are shown below.

1. A method for producing polymer microparticles,

the method comprising:

producing the polymer microparticles by polymerizing vinyl monomers in a hydrophilic solvent, which dissolves the vinyl monomers and a dispersion stabilizer but does not dissolve a polymer formed, in the presence of the dispersion stabilizer; wherein

the dispersion stabilizer contains a macromonomer having carboxyl groups and ethylenically unsaturated groups at an intermediate location in a molecular chain thereof,

the macromonomer has, on average, 1.4 to 2.5 ethylenically unsaturated groups per molecule, and

an average value of a carboxyl group content in the macromonomer is 0.5 meq/g to 2.5 meq/g.

2. The method for producing polymer microparticles according to said 1., wherein the macromonomer contains a (meth)acryloyl group.
3. The method for producing polymer microparticles according to said 1. or 2., wherein the number average molecular weight (Mn) of the macromonomer is 1000 g/mol to 10000 g/mol.
4. The method for producing polymer microparticles according to any of said 1. to 3., wherein a value (Mw/Mn) obtained by dividing a weight average molecular weight (Mw) by the number average molecular weight (Mn) of the macromonomer is 2.3 or less.
5. A polymer microparticle obtained with the production method according to said any of said 1. to 4., wherein

a volume average particle diameter thereof is 0.7 μm to 3.0 μm,

a value of volume average particle diameter (dv)/number average particle diameter (dn) is 1.2 or less, and

the number of byproduct small particles per 1000 polymer microparticles each having a particle diameter of 0.1 μm or more is 500 or less.

Further, the present teachings are shown below.

6. A polymer microparticle, which retains a macromonomer having carboxyl groups and ethylenically unsaturated groups at an intermediate location in a molecular chain thereof; wherein

the macromonomer has, on average, 1.4 to 2.5 ethylenically unsaturated groups per molecule, and

an average value of a carboxyl group content in the macromonomer is 0.5 meq/g to 2.5 meq/g.

7. The polymer microparticle according to said 6., wherein the volume average particle diameter is 0.7 μm to 3.0 μm, a value of volume average particle diameter (dv)/number average particle diameter (dn) is 1.2 or less, and the number of byproduct small particles per 1000 polymer microparticles each having a particle diameter of 0.1 μm or more is 500 or less.
8. The polymer microparticle according to said 6. or 7., wherein the macromonomer is provided with the ethylenically unsaturated groups through a portion of the carboxyl groups at an intermediate location of the molecular chain thereof
9. A dispersion stabilizer used to produce polymer microparticles,

the dispersion stabilizer containing a macromonomer having carboxyl groups and ethylenically unsaturated groups at an intermediate location of the molecular chain thereof, wherein

the macromonomer has, on average, 1.4 to 2.5 ethylenically unsaturated groups per molecule, and

an average value of a carboxyl group content in the macromonomer is 0.5 meq/g to 2.5 meq/g.

10. A method for dispersing polymer microparticles,

the method comprising:

dispersing a polymer in the form of microparticles by polymerizing vinyl monomers in the presence of the dispersion stabilizer according to said 9. in a hydrophilic solvent that dissolves the vinyl monomers and the dispersion stabilizer but does not dissolve the polymer formed.

According to the present invention, polymer microparticles having a small particle diameter and little variation in particle diameter can be efficiently produced even under conditions of a high monomer concentration in excess of a monomer concentration of 20% by weight due to the extremely superior dispersion stabilization performance of a specific macromonomer. Extremely fine polymer microparticles having a narrow particle size distribution and uniform size can be smoothly produced with favorable productivity and at low cost while maintaining favorable dispersion stability and without causing aggregation and the like among the polymer microparticles even when using an extremely small amount of the macromonomer.

The following provides a detailed explanation of representative, non-limiting specific examples of the present disclosure with suitable reference to the drawings. This detailed explanation is merely intended to indicate details for carrying out preferable examples of the present disclosure to a person with ordinary skill in the art, and is not intended to limit the scope of the present disclosure. In addition, additional characteristics and inventions disclosed below can be used separately or in combination with other characteristics and inventions in order to further improve polymer microparticles and a production method thereof

In addition, combinations of the characteristics and steps disclosed in the following detailed explanation are not essential for carrying out the present disclosure in the broad sense, and are only described to explain representative detailed examples of the present disclosure in particular. Moreover, the various characteristics of the above-mentioned and forthcoming representative specific examples along with the various characteristics disclosed in independent and dependent claims are not required to be combined as described in the specific examples described herein or in the order in which they are listed in the providing of additional and useful embodiments of the present disclosure.

All characteristics described in the present description and/or claims are intended to be disclosed separately and mutually independently from the constitution of the characteristics described in the examples and/or claims while limiting to the disclosure and claimed specified matters at the time of initial filing. Moreover, all descriptions relating to numerical ranges and groups or populations are intended to disclose intermediate constitutions thereof while limiting to the disclosure and claimed specified matters at the time of initial filing.

### DESCRIPTION OF EMBODIMENTS

The following provides a detailed explanation of the present invention. Furthermore, in the present description, the term “(meth)acrylic” refers to acrylic and/or methacrylic, and the term “(meth)acrylate” refers to acrylate and/or methacrylate. In addition, the term “(meth)acryloyl group” refers to acryloyl and/or methacryloyl.

Carboxyl groups contained in a “macromonomer” refer to —COOH and/or —COO⁻.

In addition, weight average molecular weight (Mw) and number average molecular weight (Mn) of a polymer refer to values converted to a polystyrene standard obtained using gel permeation chromatography (GPC) under conditions to be subsequently described in the examples.

The present invention is a method for producing polymer microparticles by a method provided with a first polymerization step. More specifically, in the present invention, the method for producing polymer microparticles is provided with a step for polymerizing vinyl monomers in a hydrophilic solvent, which dissolves the vinyl monomers and a dispersion stabilizer but does not dissolve the polymer formed, in the presence of the dispersion stabilizer (first polymerization step), the dispersion stabilizer containing a macromonomer having carboxyl groups and ethylenically unsaturated groups at an intermediate location in the molecular chain thereof and having on average 1.4 to 2.5 ethylenically unsaturated groups per molecule, and wherein the average value of the carboxyl group content is 0.5 meq/g to 2.5 meq/g. In the present invention, a hydrolysis step, a separation step, a purification step, or other polymerization step and the like may be carried out as necessary after the first polymerization step.

In the first polymerization step according to the present invention, since a hydrophilic solvent is used for the polymerization solvent, microparticles composed of the polymer formed in this step are dispersed in a polymerization solvent containing a hydrophilic solvent.

In the present invention, a hydrophilic solvent is used for the polymerization solvent There are no particular limitations on the above-mentioned hydrophilic solvent provided it dissolves the vinyl monomers and dispersion stabilizer to be subsequently described but does not dissolve the polymer formed. A hydrophilic organic solvent (hydrophilic organic solvent not containing water) or mixed solvent of a hydrophilic organic solvent and water is used for this hydrophilic solvent. At that time, a hydrophilic organic solvent in which the solubility in water at 20° C. is 5 g/100 mL or more is preferably used for the hydrophilic organic solvent.

Specific examples of the hydrophilic organic solvent described above include mono-alcohols such as methanol, ethanol, isopropyl alcohol, n-butyl alcohol, isobutyl alcohol, tert-butyl alcohol, sec-butyl alcohol or tetrahydrofurfuryl alcohol; polyvalent alcohols such as ethylene glycol, glycerin or diethylene glycol; ether alcohols such as methyl cellosolve, cellosolve, isopropyl cellosolve, butyl cellosolve, ethylene glycol monomethyl ether, ethylene glycol monoethyl ether, diethylene glycol monomethyl ether or diethylene glycol monoethyl ether; ketones such as acetone or methyl ethyl ketone; esters such as methyl acetate or ethyl acetate; ethers such as tetrahydrofuran; dimethylformamide and dimethylsulfoxide. One type of hydrophilic organic solvent may be used alone or two or more types may be used in combination.

In the above-mentioned first polymerization step, the hydrophilic solvent is used by suitably selecting from among the above-mentioned hydrophilic organic solvents corresponding to, for example, the types of vinyl monomers used for polymerization or the type of polymer formed.

Among these, a lower alcohol such as methanol, ethanol or isopropyl alcohol is preferable for the hydrophilic organic solvent. As a result of using these alcohols, the dispersion stabilizing action of a dispersion stabilizer containing a specific macromonomer can be demonstrated effectively, and polymer microparticles having a small particle diameter can be stably produced.

In the first polymerization step according to the present invention, by carrying out dispersion polymerization of vinyl monomers in the presence of a dispersion stabilizer containing a specific macromonomer, in comparison with the case of polymerizing in a hydrophobic solvent, particle diameter, particle size distribution or molecular weight and the like of the polymer microparticles formed can be easily and smoothly controlled while favorably maintaining polymerization stability.

In the present invention, the hydrophilic solvent is preferably a mixed solvent containing water and an alcohol, and among these, more preferably a mixed solvent composed of water and at least one type of alcohol selected from the group consisting of lower alcohols such as methanol, ethanol or isopropyl alcohol. In the case of using a mixed solvent of water and the above-mentioned alcohols for the hydrophilic solvent, particle diameter, particle size distribution or molecular weight and the like of the polymer microparticles formed can be easily controlled by adjusting the mixing ratio of the water and alcohol corresponding to, for example, the types and composition of the vinyl monomers. In addition, the risk of ignition or explosion can be reduced and there is little burden on the environment.

In particular, if a mixed solvent of water and methanol is used in which the mass ratio of water to methanol is preferably 10:90 to 50:50 and more preferably 20:80 to 40:60 or less, polymer microparticles having a smaller particle diameter and narrower particle size distribution can be smoothly produced, thereby making this even more preferable.

Furthermore, a portion of the hydrophilic solvent used in the first polymerization step may be substituted for a hydrophobic solvent having solubility in water at 20° C. of less than 5 g/100 ml. In this case, the percentage of the hydrophobic solvent is preferably 30% by mass or less, more preferably 15% by mass or less and even more preferably 5% by mass or less based on the total amount of solvent. In the case the contained percentage of the hydrophobic solvent exceeds 30% by mass, the particle size distribution of the formed particles may become wider or aggregates may be formed in the first polymerization step.

In the first polymerization step according to the present invention, a dispersion stabilizer containing a specific macromonomer having carboxyl groups and ethylenically unsaturated groups at an intermediate location in the molecular chain thereof (to also be referred to as “macromonomer (Ma)”) is used for the dispersion stabilizer during dispersion polymerization of the vinyl monomers. The contained percentage of the macromonomer (Ma) in the dispersion stabilizer is preferably 20% by mass to 100% by mass and more preferably 50% by mass to 100% by mass. If the contained amount of the macromonomer (Ma) is excessively low, the effects of the present invention may be unable to be adequately obtained.

In addition, the above-mentioned dispersion stabilizer may contain other polymers. Namely, the above-mentioned dispersion stabilizer can be in the form of a polymer composition composed of the macromonomer (Ma) and other polymers (mixture composed of polymers). In the case the above-mentioned dispersion stabilizer contains other polymers, the contained percentage of the macromonomer (Ma) is preferably 10% by mass to 100% by mass and more preferably 30% by mass to 100% by mass based on the amount of all polymers.

Examples of other polymers include polymers having a functional group such as a carboxyl group, hydroxyl group, amide group, pyrrolidone group or morpholine group.

Furthermore, the above-mentioned dispersion stabilizer may also be composed of the macromonomer (Ma) or a polymer composition and an additive that does not impair dispersion polymerization of the vinyl monomers.

The above-mentioned macromonomer (Ma) is a polymer having carboxyl groups and ethylenically unsaturated groups at an intermediate location in the molecular chain thereof.

Furthermore, the carboxyl groups and ethylenically unsaturated groups contained in this macromonomer (Ma) are at least bound (present) at an intermediate location of the molecular chain (polymer chain) and not on an end of the molecular chain (polymer chain) that composes the macromonomer (Ma).

Examples of groups having an ethylenically unsaturated group contained in the macromonomer (Ma) include a (meth)acryloyl group, allyl group, isopropenyl group and styryl group. Furthermore, the macromonomer (Ma) can have one type or two or more types of these groups. In addition, a macromonomer having ethylenically unsaturated groups at both an intermediate location and on the ends of the molecular chain thereof can also be used for the above-mentioned macromonomer (Ma).

The group having an ethylenically unsaturated group is preferably a (meth)acryloyl group. If the macromonomer (Ma) having carboxyl groups and (meth)acryloyl groups at an intermediate location in the molecular chain thereof is used, reactivity of the vinyl groups and dispersion stabilization performance can be improved. Fine polymer microparticles having a narrow particle size distribution and uniform size can be stably produced without causing the formation of aggregates and the like among the polymer microparticles despite using a smaller amount of dispersion stabilizer containing the macromonomer (Ma).

In addition, the ethylenically unsaturated groups contained in the above-mentioned macromonomer (Ma) may be directly bonded at an intermediate location in the molecular chain of the macromonomer (Ma) or may be bonded in dangling state through a prescribed linking group at an intermediate location in the molecular chain of the macromonomer (Ma). Moreover, these two bonding forms may be mixed.

On the other hand, the carboxyl groups contained in the above-mentioned macromonomer (Ma) are at least present at an intermediate location in the molecular chain or may be present at both an intermediate location and the ends of the molecular chain. In addition, the carboxyl groups may be directly bonded at an intermediate location in the molecular chain of the macromonomer (Ma) or may be bonded in a dangling state through a prescribed linking group at an intermediate location in the molecular chain of the macromonomer (Ma). Moreover, these two bonding forms may be mixed.

The content of the carboxyl groups contained at an intermediate location in the molecular chain of the macromonomer (Ma) is preferably 0.5 meq to 2.5 meq per gram of the macromonomer (Ma). More preferably, the lower limit of the content of the carboxyl groups is 0.50 meq or more, even more preferably 0.6 meq or more, still more preferably 0.7 meq or more, even more preferably 0.8 meq or more and still more preferably 1.0 meq or more per gram of the macromonomer (Ma). In addition, the upper limit of the content of the carboxyl groups is more preferably 2.1 meq or less and even more preferably 2.0 meq or less per gram of the macromonomer (Ma). In addition, the content of the carboxyl groups is preferably 1.0 meq to 2.0 meq per gram of the macromonomer (Ma).

If the content of the carboxyl groups in the macromonomer (Ma) is excessively low, the dispersion stabilization performance of the macromonomer (Ma) decreases easily, while if the content of the carboxyl groups is excessively high, secondary production of small particles is frequently observed, which may cause the particle size distribution of the polymer microparticles to become wider or the size thereof to lack uniformity.

The carboxyl groups present at an intermediate location in the molecular chain of the macromonomer (Ma) are preferably neutralized by a base. The carboxyl groups dissociate into carboxyl anions in the hydrophilic solvent and demonstrate electrostatic repulsion as a result of being neutralized, thereby making it possible to inhibit aggregation among polymer microparticles with a smaller amount of dispersion stabilizer and allowing the production of polymer microparticles demonstrating greater stability due to further improvement of the dispersion stabilization performance of the dispersion stabilizer containing the macromonomer (Ma).

Ammonia and/or a low boiling point amine compound is preferably used for the carboxyl group neutralizing agent since it can be easily removed following production of the polymer microparticles, for example.

The macromonomer (Ma) is preferably a chain polymer having a chain molecular structure from the viewpoints of, for example, greater dispersion stabilization effects, greater ease of production and easier handling. In the case the macromonomer (Ma) is a chain polymer, the chain structure may be any of a linear, branched, star-shaped or comb-shaped structure, and among these, a linear structure or nearly linear structure is preferable from the viewpoints of, for example, dispersion stabilization performance, production ease and handling ease of the macromonomer (Ma).

The above-mentioned macromonomer (Ma) is preferably a macromonomer obtained by adding a compound having epoxy groups and ethylenically unsaturated groups (to also be referred to as “compound (α)”) to a portion of the carboxyl groups of a polymer (A) having carboxyl groups at an intermediate location in the molecular chain thereof (to also be referred to as “macromonomer (Mal)”). This macromonomer (Mal) has a high degree of freedom in the structural design thereof and demonstrates superior dispersion stabilization performance in the first polymerization step.

The number average molecular weight (Mn) of the macromonomer (Ma) is preferably 1,000 to 10,000 and more preferably 2,000 to 5,000 from the viewpoints of, for example, dispersion stabilization performance, handling ease and ease of production.

In addition, the molecular weight distribution of the macromonomer (Ma), namely the value (Mw/Mn) obtained by dividing the weight average molecular weight (Mw) by the number average molecular weight (Mn), is preferably 2.3 or less and more preferably 2.0 or less from the viewpoint of suppressing the secondary production of small particles.

There are no particular limitations on the production method of the macromonomer (Ma). For example, in the case the macromonomer (Ma) is the macromonomer (Mal), a precursor in the form of the polymer (A) having carboxyl groups at an intermediate location in the molecular chain thereof is reacted with the compound (α) having epoxy groups and ethylenically unsaturated groups.

In the above-mentioned polymer (A), the carboxyl groups may be directly bonded at an intermediate location in the molecular chain of the polymer (A), may be bonded in a dangling state through a prescribed linking group at an intermediate location in the molecular chain of the polymer (A), or the two bonding forms may be mixed.

In addition, the above-mentioned polymer (A) is preferably a polymer having a linear molecular structure and having carboxyl groups at an intermediate location in the molecular chain thereof.

Although there are no particular limitations thereon, the production method of the above-mentioned polymer (A) is preferably homopolymerization or copolymerization of vinyl monomers having carboxyl groups, or copolymerization of vinyl monomers having carboxyl groups and other vinyl monomers from the viewpoints of a greater degree of design freedom with respect to polymer molecular weight, composition or the like, and of the obtaining of the macromonomer (Mal) having higher performance as a dispersion stabilizer.

Examples of vinyl monomers having carboxyl groups used to produce the polymer (A) include unsaturated carboxylic acids such as acrylic acid, methacrylic acid, crotonic acid, itaconic acid or maleic acid; Micheal addition reaction products of an unsaturated carboxylic acid such as acrylic acid or methacrylic acid in the form of dimer or larger oligomers; and, carboxyl group-containing (meth)acrylates such as m-carboxypolycaprolactone mono(meth)acrylate, monohydroxyethyl phthalate (meth)acrylate or monohydroxyethyl succinate (meth)acrylate. One type of these compounds may be used alone or two or more types may be used in combination.

Vinyl monomers not having carboxyl groups can be used for the other vinyl monomers able to be copolymerized with the vinyl monomers having carboxyl groups in order to produce the polymer (A). These monomers may be hydrophilic monomers or hydrophobic monomers.

Among these, hydrophobic vinyl monomers are preferable. An addition reaction of the above-mentioned compound (α) to a portion of the carboxyl groups in the polymer (A) having a structural unit derived from a hydrophobic vinyl monomer makes it possible to further improve the dispersion stabilization performance demonstrated by the resulting macromonomer (Mal).

Specific examples of hydrophobic vinyl monomers capable of polymerizing with vinyl monomers having carboxyl groups include (meth)acrylate esters such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, n-octyl (meth)acrylate, 2-ethylhexyl (meth)acrylate, stearyl (meth)acrylate, lauryl (meth)acrylate, decyl (meth)acrylate, cyclohexyl (meth)acrylate, isobornyl (meth)acrylate, benzyl (meth)acrylate or perfluoroalkyl (meth)acrylate; unsaturated nitrile monomers such as acrylonitrile or α-methylacrylonitrile; styrene-based monomers such as styrene or α-methylstyrene; vinyl esters of carboxylic acids such as vinyl acetate; unsaturated halogen compounds such as vinyl chloride or vinylidene chloride; and olefins such as ethylene, propylene or isobutylene. One type of these compounds may be used alone or two or more types may be used in combination.

A copolymer of a vinyl monomer having carboxyl groups and hydrophobic vinyl monomer is preferable for the above-mentioned polymer (A). In particular, a copolymer having carboxyl groups in which the copolymerization ratio of the vinyl monomer having a carboxyl group to the hydrophobic vinyl monomer, in terms of the mass ratio, is preferably 95:5 to 10:90 and more preferably 80:20 to 20:80 is preferable. The use of this copolymer enables the macromonomer (Mal) having superior dispersion stabilization performance to be smoothly obtained. A specific example of this copolymer is a copolymer in which acrylic acid and/or methacrylic acid is used for the vinyl monomer having carboxyl groups and one or more types of hydrophobic vinyl monomers selected from (meth)acrylate ester and styrene are used for the other monomers. This copolymer is preferable from the viewpoint of, for example, dispersion stabilization performance and properties of the resulting polymer microparticles.

An aliphatic lower alcohol ester of (meth)acrylic acid such as methyl (meth)acrylate or isobutyl (meth)acrylate or an alicyclic alcohol ester such as cyclohexyl (meth)acrylate is preferable for the (meth)acrylate ester. In particular, an aliphatic lower alcohol ester of (meth)acrylic acid is used preferably from the viewpoint of forming the macromonomer (Mal) having a superior dispersion stabilization effect.

The number of equivalents of the carboxyl groups contained in the polymer (A) (number of moles of carboxyl groups per 1 g of the polymer (A)) is preferably 1.0 meq/g to 4.0 meq/g and more preferably 1.5 meq/g to 3.0 meq/g.

In addition, the number average molecular weight (Mn) of the polymer (A) is preferably 1,000 to 10,000 and more preferably 2,000 to 5,000. The use of the polymer (A) having the above-mentioned number average molecular weight (Mn) enables the formation of the macromonomer (Mal) that is superior in terms of, for example, dispersion stability performance, handling ease and properties of the resulting polymer microparticles.

The molecular weight distribution (Mw/Mn) of the polymer (A) is preferably 2.3 or less and more preferably 2.0 or less. The use of the polymer (A) having the above-mentioned value for (Mw/Mn) enables the formation of the macromonomer (Mal) that is capable of inhibiting the secondary production of small particles during production of polymer microparticles.

A molecular weight modifier may be used in producing the polymer (A), and examples of molecular weight modifiers include mercapto compounds such as octyl thioglycolate, butyl mercaptan or dodecyl mercaptan.

Emulsion polymerization is preferable for the polymerization method used to obtain the polymer (A). Emulsion polymerization demonstrates a rapid polymerization rate and enables the distribution of components in the polymer to be narrowed. Since the polymer (A) is obtained in the form of submicron-sized microparticles, an addition reaction of the compound (α) to the polymer (A) can be completed in an extremely short period of time.

Emulsion polymerization for obtaining the polymer (A) can be carried out using a method and polymerization conditions similar to those of conventional general-purpose emulsion polymerization carried out in water or an aqueous medium using only vinyl monomers having carboxyl groups or using a vinyl monomer having carboxyl groups and other vinyl monomer. The use of the above-mentioned hydrophobic vinyl monomer is preferable for the other vinyl monomer from the viewpoint of being able to stably carry out emulsion polymerization. In carrying out emulsion polymerization, a polymerization initiator (polymerization catalyst) such as an organic peroxide, azo-based compound or persulfuric acid-based compound to be subsequently described can be used in the same manner as when used in the first polymerization step (dispersion polymerization) for producing the polymer microparticles. In addition, an emulsifier may also be used as necessary. A persulfuric acid-based initiator such as ammonium persulfate or potassium persulfate is more preferably used for the initiator since emulsion polymerization can be carried out stably without using an emulsifier due to the stabilization effect resulting from the polymerization initiator segment.

In addition, the compound (α) is a compound having epoxy groups and ethylenically unsaturated groups.

Examples of groups containing an ethylenically unsaturated group possessed by the compound (α) include a (meth)acryloyl group, allyl group, isopropenyl group and styryl group. Among these, the compound (α) preferably contains a (meth)acryloyl group from the viewpoint of obtaining the macromonomer (Mal) having high reactivity and dispersion stabilization effects.

Specific preferable examples of the compound (α) include glycidyl (meth)acrylate, 3,4-epoxycyclohexylmethyl (meth)acrylate and 4-hydroxybutyl (meth)acrylate glycidyl ether. One type of these compounds may be used alone or two or more types may be used in combination.

When the compound (α) having epoxy groups and ethylenically unsaturated groups is reacted with the polymer (A), the epoxy groups in the compound (α) are added to a portion of the carboxyl groups present at an intermediate location in the molecular chain of the polymer (A), and the macromonomer (Mal) is obtained in which the ethylenically unsaturated groups are introduced at an intermediate location in the molecular chain of the polymer (A). Namely, the macromonomer (Mal) is formed having ethylenically unsaturated groups and carboxyl groups present at an intermediate location in the molecular chain thereof. Furthermore, the macromonomer (Mal) and unreacted polymer (A) may be present in the reaction system, and normally both are present. In the present invention, a mixture consisting of these polymers can be used as a dispersion stabilizer.

In the case of producing the above-mentioned polymer (A) by emulsion polymerization, the addition reaction of the compound (α) to the polymer (A) can be carried out using a microparticle dispersion of the polymer (A). After having produced the polymer (A), the compound (α) is preferably added to a dispersion of the polymer (A) while maintaining in a dispersed state (suspended state). As a result, since the addition reaction proceeds within particles of the polymer (A), the reaction rate is extremely fast and side reactions between the compound (α) and water are inhibited. In addition, water is used for the solvent, which is preferable in terms of costs, environmental considerations, and not having to introduce other organic solvents at the stage of dispersion polymerization.

During the addition reaction of the compound (α) to the polymer (A), the amount of the compound (α) added in the reaction is preferably 1.6 moles to 2.2 moles (namely, 1.6 equivalents to 2.2 equivalents) and more preferably 1.6 moles to 2.0 moles (namely, 1.6 equivalents to 2.0 equivalents) based on 1 mole of the polymer (A). Furthermore, the number of moles of the polymer (A) can be determined by dividing the mass of the actually used polymer (A) by the number average molecular weight (Mn) of the polymer (A).

Namely, the number of moles of the compound (α) added to 1 mole of the polymer (A) refers to the average introduction rate (f value) of ethylenically unsaturated groups per molecule (per polymer chain) of the macromonomer (Mal). Furthermore, in actuality, the amount of the compound (α) added in the reaction per molecule of the polymer (A) has a certain distribution and unreacted polymer (A) to which the compound (α) has not been added is also present, thereby forming a composition.

The average content of ethylenically unsaturated groups per molecule of polymer among all polymers containing the macromonomer (Mal) in the resulting polymer composition containing the macromonomer (Mal) (mixture composed of polymers) is 1.4 to 2.5, preferably 1.6 to 2.2 and more preferably 1.6 to 2.0.

Furthermore, in the case of preparing the above-mentioned dispersion stabilizer using this polymer composition or macromonomer (Ma), other polymers may be incorporated as previously described. In this case, the average content of ethylenically unsaturated groups per molecule of polymer as calculated on the basis of all polymers contained in the dispersion stabilizer is preferably 1.4 to 2.5. The lower limit thereof is more preferably 1.5 or more, even more preferably 1.8 or more and still more preferably 1.9 or more. In addition, the upper limit thereof is more preferably 2.3 or less, even more preferably 2.2 or less and still more preferably 2.0 or less. In addition, the average content of ethylenically unsaturated groups is preferably 1.6 to 2.2 and more preferably 1.6 to 2.0. If the content of ethylenically unsaturated groups is within the above-mentioned ranges, the effects of the dispersion stabilizer are adequately demonstrated.

If the content of ethylenically unsaturated groups is excessively low, dispersion stabilization performance decreases and there is increased susceptibility to deterioration in the properties of the resulting polymer microparticles.

On the other hand, if the content of ethylenically unsaturated groups is excessively high, the particle size distribution of polymer microparticles obtained by dispersion polymerization of vinyl monomers widens and the size thereof tends to lack uniformity

In addition, in a polymer composition containing the macromonomer (Mal) obtained by reacting the compound (α) with the polymer (A), the average value D (units: meq/g) of the content of carboxyl groups of all polymers containing the macromonomer (Mal) is determined from the following Equation (1) based on the addition rate of the compound (α) to the polymer (A):

D=(X−Z)/(100+Y) (1)

wherein,
X=amount of carboxyl groups of polymer (A) (meq/g)×100=amount of carboxyl groups per 100 parts by mass of polymer (A) (meq)
Y={charged amount of compound (α) per 100 parts by mass of polymer (A)}×(addition rate of compound (α) to polymer (A))
Z={Y/molecular weight of compound (α)}×1000=amount (meq) of compound (α) added to 100 parts by mass of polymer (A).

Furthermore, in the case of preparing the dispersion stabilizer using the above-mentioned polymer composition containing the macromonomer (Mal), other polymers may also be incorporated as previously described. The average value of the content of carboxyl groups as calculated based on all polymers contained in the dispersion stabilizer is preferably 0.5 meq/g to 2.5 meq/g. The lower limit thereof is preferably 0.50 meq/g or more. In addition, the lower limit thereof is more preferably 0.6 meq/g or more, even more preferably 0.7 meq/g or more, still more preferably 0.8 meq/g or more, and more preferably still 1.0 meq/g or more. In addition, the upper limit thereof is more preferably 2.1 meq/g or less and even more preferably 2.0 meq/g or less. In addition, the average of the content of carboxyl groups is more preferably 1.0 meq/g to 2.0 meq/g. If the content of carboxyl groups is within the above-mentioned ranges, the effects of the dispersion stabilizer are adequately demonstrated.

A catalyst in the form of a tertiary amine compound, quaternary ammonium salt compound or phosphine compound can be used in carrying out the addition reaction of the compound (α) to the polymer (A) in order to increase the addition reaction rate. A tertiary amine compound such as triethylamine is used particularly preferably since it also fulfills the role of a neutralizing agent of carboxyl groups possessed by the polymer (A). In the case of carrying out the addition reaction in an aqueous medium in particular, the use of a catalyst is more preferable since a side reaction, by which the compound (α) undergoes an addition reaction with water, is reduced.

Performance as a dispersion stabilizer can be further improved by using a base to neutralize carboxyl groups remaining in the macromonomer (Mal) obtained by the addition reaction of the compound (α) to a portion of the carboxyl groups of the polymer (A) as previously described.

Although not limited thereto, reaction conditions are such that the addition reaction of the compound (α) to the polymer (A) is carried out by adding the compound (α) to a solution or dispersion of the polymer (A) and normally heating to 50° C. to 120° C.

The polymer composition containing macromonomer (Mal) obtained by the addition reaction of the compound (α) to the polymer (A) demonstrates extremely superior dispersion stabilization performance. Namely, as a result of carrying out dispersion polymerization on vinyl monomers in a polymerization solvent containing a hydrophilic solvent in the presence of a dispersion stabilizer containing the above-mentioned macromonomer (Ma), ethylenically unsaturated groups present at an intermediate location in the molecular chain of the macromonomer (Ma) copolymerize with vinyl monomers, and an extremely high level of dispersion stability can be imparted to polymer microparticles formed by polymerization of the vinyl monomers. This high level of dispersion stability is achieved due to the ethylenically unsaturated groups being located at an intermediate location in the molecular chain of the macromonomer (Ma) and the macromonomer (Ma) having carboxyl groups at an intermediate location in the molecular chain thereof.

Next, an explanation is provided of the vinyl monomers for producing polymer microparticles in the first polymerization step.

Vinyl monomers that dissolve in the hydrophilic solvent prior to polymerization but does not dissolve in the hydrophilic solvent after polymerization can be used for the above-mentioned vinyl monomers.

The vinyl monomers used in dispersion polymerization are suitably selected according to, for example, the type and composition of the hydrophilic solvent, and examples thereof include (meth)acrylate esters; styrene-based monomers such as styrene or α-methylstyrene, and vinyl monomers having a hydrolyzable silyl group. One type of these monomers may be used alone or two or more types may be used in combination. In addition, these monomers are preferable from the viewpoint of superior control of dispersibility and light diffusion when the resulting polymer microparticles are added to various types of resins.

Specific examples of the above-mentioned (meth)acrylate ester preferably used as vinyl monomer include alkyl esters of (meth)acrylic acid such as methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, pentyl (meth)acrylate, n-hexyl (meth)acrylate, n-octyl (meth)acrylate, 2-ethylhexyl (meth)acrylate, lauryl (meth)acrylate or stearyl (meth)acrylate; alicyclic group-containing esters of (meth)acrylic acid such as cyclohexyl (meth)acrylate or isobornyl (meth)acrylate; heterocyclic group-containing esters of (meth)acrylic acid such as glycidyl (meth)acrylate or tetrahydrofurfuryl (meth)acrylate; hydroxyalkyl esters of (meth)acrylic acid such as 2-hydroxyethyl (meth)acrylate or hydroxypropyl (meth)acrylate; alkoxyalkyl esters of (meth)acrylic acid such as 2-methoxyethyl (meth)acrylate; polyvalent alcohol esters of (meth)acrylic acid such as ethylene glycol di(meth)acrylate, trimethylolpropane tri(meth)acrylate, pentaerythritol tri(meth)acrylate or pentaerythritol tetra(meth)acrylate; and, allyl (meth)acrylates. One type of these compounds may be used alone or two or more types may be used in combination.

In addition, there are no particular limitations on the above-mentioned vinyl monomer having a hydrolyzable silyl group provided it is a vinyl monomer having at least one hydrolyzable silyl group. Examples thereof include vinylsilanes such as vinyltrimethoxysilane, vinyltriethoxysilane, vinylmethyldimethoxysilane or vinyldimethylmethoxysilane; silyl group-containing acrylate esters such as trimethoxysilylpropyl acrylate, triethoxysilylpropyl acrylate or methyldimethoxysilylpropyl acrylate; silyl group-containing methacrylate esters such as trimethoxysilylpropyl methacrylate, triethoxysilylpropyl methacrylate, methyldimethoxysilylpropyl methacrylate or dimethylmethoxysilylpropyl methacrylate; silyl group-containing vinyl ethers such as trimethoxysilylpropyl vinyl ether; and silyl group-containing vinyl esters such as vinyl trimethoxysilylundecanoate. One type of these compounds may be used alone or two or more types may be used in combination.

Among these, the vinyl monomer having a hydrolyzable silyl group is preferably a hydrolyzable silyl group-containing acrylate ester or hydrolyzable silyl group-containing methacrylate ester, and particularly preferably triethoxysilylpropyl methacrylate (trimethoxysilylpropyl methacrylate).

In order to obtain polymer microparticles having a narrow particle size distribution, uniform size and superior properties and handling by smoothly carrying out dispersion polymerization while preventing aggregation among the polymer microparticles formed, the above-mentioned vinyl monomers preferably include a (meth)acrylate ester. The amount of this (meth)acrylate ester used is preferably 60% by mass or more, more preferably 65% by mass or more and even more preferably 70% by mass or more based on the total mass of vinyl monomers used to produce the polymer microparticles. The (meth)acrylate ester used at that time is preferably an alkyl ester having 1 to 12 carbon atoms or a cycloalkyl ester having 3 to 12 carbon atoms of (meth)acrylic acid. An alkyl ester having 1 to 4 carbon atoms of (meth)acrylic acid is particularly preferable from the viewpoint of superior performance of the resulting polymer microparticles.

In the production of polymer microparticles, the use of polyfunctional vinyl monomers having two or more ethylenically unsaturated groups (vinyl groups) and/or vinyl monomers having a hydrolyzable silyl group allows the production of polymer microparticles having superior heat resistance and solvent resistance.

In the case the above-mentioned vinyl monomers include a polyfunctional vinyl monomer, microparticles composed of a crosslinked polymer can be produced in the first polymerization step.

In addition, in the case the above-mentioned vinyl monomers include a vinyl-based monomer having a hydrolyzable silyl group, although microparticles composed of a crosslinked polymer resulting from crosslinking of siloxane may be contained in the first polymerization step, microparticles are normally produced that are composed of a non-crosslinked polymer (polymer having a hydrolyzable silyl group). Microparticles composed of a crosslinked polymer can be obtained by carrying out a hydrolysis step to be subsequently described after the first polymerization step.

If the resulting microparticles are composed of a crosslinked polymer, there is little or no dissolution or transformation thereof with respect to an organic solvent such as methyl ethyl ketone. Thus, microparticles composed of a crosslinked polymer can be preferably used in applications requiring solvent resistance or heat resistance.

If polyfunctional vinyl monomers having two or more ethylenically unsaturated groups are used in the first polymerization step, crosslinking proceeds in conjunction with the progression of polymerization. Consequently, the polymer microparticles end up aggregating easily if the proportion of the polyfunctional vinyl monomers is excessively large. In the case of producing crosslinked polymer microparticles using polyfunctional vinyl monomers, the proportion at which the polyfunctional vinyl monomers are used is preferably made to be 0.5% by mass to 10% by mass based on the total amount of vinyl monomers used to produce the polymer microparticles.

Examples of polyfunctional vinyl monomers include polyvalent alcohol esters of (meth)acrylic acid such as ethylene glycol di(meth)acrylate, trimethylolpropane tri(meth)acrylate, pentaerythritol tri(meth)acrylate or pentaerythritol tetra(meth)acrylate, and allyl (meth)acrylates. One type of these compounds may be used alone or two or more types may be used in combination.

Among these, allyl (meth)acrylates are preferable from the viewpoint of the ease of inhibiting aggregation among polymer microparticles during dispersion polymerization.

In the case of using vinyl monomers having a hydrolyzable silyl group in the first polymerization step, crosslinking reactions can be inhibited during polymerization by maintaining the pH of the reaction solution in the vicinity of neutral during dispersion polymerization. Crosslinked polymer microparticles can then be obtained by adding an acid catalyst or basic catalyst following polymerization and carrying out a hydrolysis-condensation-siloxane formation reaction on hydrolyzable silyl groups present in non-crosslinked polymer microparticles. A low boiling point basic compound such as ammonia or triethylamine is preferable for the catalyst. The use of these compounds facilitates removal following the hydrolysis-condensation reaction.

In the case of producing crosslinked polymer microparticles using vinyl monomers having a hydrolyzable silyl group, the proportion of vinyl monomers having a hydrolyzable silyl group used is preferably 0.5% by mass to 50% by mass and more preferably 1% by mass to 30% by mass based on the total amount of vinyl monomers.

One type of the previously exemplified compounds may be used alone or two more types may be used in combination for the vinyl monomers having a hydrolyzable silyl group.

Vinyl monomers are subjected to dispersion polymerization in a hydrophilic solvent in the presence of a dispersion stabilizer containing the macromonomer (Ma) in the first polymerization step.

Examples of polymerization methods include batch polymerization, in which the vinyl monomers are subjected to dispersion polymerization by charging all at once into a reactor, divided polymerization, in which the vinyl monomers are subjected to dispersion polymerization by charging into a reactor after dividing into multiple aliquots, and continuous addition polymerization (semi-batch polymerization), in which the vinyl monomers are subjected to dispersion polymerization by continuously adding to a reactor. Continuous addition polymerization is used preferably in cases requiring control of the heat of polymerization.

The amount of dispersion stabilizer (solid fraction) containing the macromonomer (Ma) used when producing polymer microparticles by subjecting vinyl monomers to dispersion polymerization is preferably 0.2% by mass to 10% by mass and more preferably 0.5% by mass to 5.0% by mass based on the total amount of vinyl monomers used in dispersion polymerization. If the amount of dispersion stabilizer containing the macromonomer (Ma) used is excessively low, stability during polymerization decreases resulting in greater susceptibility to the occurrence of aggregation and the like of the polymer formed. On the other hand, if the amount of dispersion stabilizer used is excessively high, the particle size distribution of the formed polymer microparticles widens and the size thereof tends to lack uniformity.

The amount of hydrophilic solvent used during dispersion polymerization of vinyl monomers is preferably 1 part by mass to 50 parts by mass and more preferably 2 parts by mass to 10 parts by mass based on the total amount of vinyl monomers. If the amount of hydrophilic solvent used is excessively low, dispersion stability may become poor during dispersion polymerization, which tends to result in widening of the distribution of particle size. On the other hand, if the amount of hydrophilic solvent used is excessively high, the yield of the polymer microparticles decreases, which tends to result in poor productivity.

A polymerization initiator normally used in radical polymerization can be used as a polymerization initiator during dispersion polymerization of the vinyl monomers, and there are no particular limitations thereon. Among these, a radical polymerization initiator that dissolves in a hydrophilic solvent is used preferably. Examples of radical polymerization initiators able to be used in the present invention include organic peroxides such as t-butylperoxypivalate, t-butylperoxy-2-ethylhexanoate, di-t-butyl peroxide, benzoyl peroxide, lauroyl peroxide, benzoyl orthochloroperoxide, benzoyl orthomethoxyperoxide or 3,5,5-trimethyhexanoyl peroxide; azo-based compounds such as azobisisobutyronitrile, azobiscyclohexacarbonitrile, azobis(2,4-dimethylvaleronitrile), 2,2′-azobis(2-amidinopropane) dihydrochloride (V-50) or 4,4′-azobis(4-cyanovaleric acid) (V-501); and, persulfate-based compounds such as potassium persulfate. One type of the above-mentioned polymerization initiators may be used alone or two or more types may be used in combination.

Among these, t-butylperoxypivalate or azobis(2,4-dimethylvaleronitrile) is used preferably for the polymerization initiator from the viewpoint of being able to produce polymer microparticles having a narrow particle size distribution with favorable productivity.

The amount of polymerization initiator used is not limited specifically and can be suitably determined in consideration of such factors as the molecular weight of the polymer microparticles produced or the decomposition temperature of the polymerization initiator used. In general, polymerization initiator is preferably used at 0.1 parts by mass to 40 parts by mass and more preferably at 1 part by mass to 10 parts by mass based on a total of 100 parts by mass of the vinyl monomers. If the amount of polymerization initiator used is excessively low, the yield of polymer microparticles tends to decrease, while if the amount of polymerization initiator used is excessively high, the polymerization rate becomes excessively fast and it becomes difficult to stably carry out dispersion polymerization.

The polymerization temperature during dispersion polymerization in the first polymerization step is preferably 40° C. to 80° C. and more preferably 45° C. to 70° C. If the polymerization temperature is excessively low, the vinyl monomer polymerization rate decreases and it is difficult to produce polymer microparticles with favorable productivity, while if the polymerization temperature is excessively high, there is increased susceptibility to the occurrence of aggregation and the like among the polymer microparticles formed, and the particle size distribution of the polymer microparticles widens.

In the present invention, other additives may be used in combination with the dispersion stabilizer composed of the macromonomer (Ma) in order to further improve dispersion stability of the polymer microparticles formed, further narrow particle size distribution, impart magnetic properties or electrical conductivity to the polymer microparticles, or color the polymer microparticles. Examples of other additives include powders composed of metals such as cobalt, iron or aluminum, alloys thereof or metal oxides such as iron oxide, copper oxide or nickel oxide; pigments and dyes such as carbon black nigrosine dye or aniline blue; anionic surfactants such as higher alcohol sulfuric acid ester salts, alkyl benzyl sulfonates, α-olefin sulfonates or phosphate esters; nonionic surfactants such as fatty acid amide derivatives or polyvalent alcohol derivatives; and highly polar polymeric compounds such as hydroxypropyl cellulose, polyacrylic acid, polyvinylpyrrolidone, polyethylene glycol or polyvinyl alcohol One type of these compounds may be used alone or two or more types may be used in combination.

The polymer microparticles formed by dispersion polymerization may be used in the state of a dispersion of the polymer microparticles while still dispersed in a hydrophilic solvent, or may be used after separating and recovering from the hydrophilic solvent.

Methods such as precipitation separation, centrifugal separation or decantation can be used for the method used to separate and recover polymer microparticles from the hydrophilic solvent, and washing and drying are further carried out as necessary.

In the first polymerization step of the present invention, the polymer formed successively precipitates and aggregates without dissolving in the hydrophilic solvent as polymerization begins. At that time, since a graft polymer having extremely high dispersion stabilization effects is simultaneously and efficiently formed by copolymerization of the macromonomer (Ma) and vinyl monomers, a greater number of stable particles are formed at an extremely early stage of polymerization. Moreover, at the stage polymerization of the vinyl monomers progresses, the above-mentioned graft polymer (formed by copolymerization of the macromonomer (Ma) and the vinyl monomers) is mainly formed on the surfaces of growing particles in coordination with the rate at which the initially formed stable particles grow as polymerization progresses. Consequently, aggregation among particles and the generation of new particles is highly inhibited. Polymer microparticles having extremely superior monodispersivity and a narrow particle size distribution can be produced stably and easily with good reproducibility even under conditions of a high monomer concentration. In addition, in the present invention, smaller (and therefore, a greater number of) initially stabilized particles can be formed in comparison with the case of using a conventional dispersion stabilizer due to the effects of the macromonomer (Ma). Since the growth thereof can also be allowed to proceed stably, smaller polymer microparticles can be produced that demonstrate superior monodispersivity.

The polymer microparticles obtained in the first polymerization step may be used without subjecting to crosslinking treatment and the like, may be used after further subjecting to crosslinking treatment and the like as necessary, or may be subjected to treatment consisting of, for example, the introduction of new functional groups.

In the case the above-mentioned polymer microparticles are not crosslinked in particular, these polymer microparticles can be further provided to a reaction by using as seed particles. For example, vinyl monomers including a polyfunctional vinyl monomer can be absorbed onto the seed particles followed by polymerization (second polymerization step). This second polymerization step allows the obtaining of crosslinked polymer microparticles having improved heat resistance, chemical resistance, strength and solvent resistance.

Polyfunctional (meth)acrylate compounds, polyfunctional allyl compounds, polyfunctional propenyl compounds or divinylbenzene and the like are preferably used for the above-mentioned polyfunctional vinyl monomer. One type of these compounds may be used alone or two or more types may be used in combination.

Examples of polyfunctional (meth)acrylate compounds include di(meth)acrylates of divalent alcohols such as ethylene glycol di(meth)acrylate, propylene glycol di(meth)acrylate, 1,6-hexandiol di(meth)acrylate, polyethylene glycol di(meth)acrylate or polypropylene glycol di(meth)acrylate; and, poly(meth)acrylates such as tri(meth)acrylates or tetra(meth)acrylates of polyvalent alcohols having a valence of 3 or more such as trimethylolpropane tri(meth)acrylate, trimethylolpropane ethylene oxide-modified tri(meth)acrylate, glycerin tri(meth)acrylate, pentaerythritol tri(meth)acrylate or pentaerythritol tetra(meth)acrylate. One type of these compounds may be used alone or two or more types may be used in combination. Among these, ethylene glycol di(meth)acrylate and trimethylolpropane tri(meth)acrylate are used preferably from the viewpoints of, for examolem, facilitating absorption to the seed particles, making it possible to further increase crosslink density, and demonstrating superior polymer stability.

Vinyl monomers that have been polymerized by absorbing to seed particles composed of polymer microparticles obtained according to the first polymerization step are preferably a mixture of vinyl monomers containing a monofunctional vinyl monomer together with the above-mentioned polyfunctional vinyl monomer from the viewpoints of improving absorption of vinyl monomer to the seed particles and improving polymerization stability. The use of a vinyl monomer that is the same as or similar to the vinyl monomer used to produce the seed particles (polymer microparticles obtained by dispersion polymerization) for the monofunctional vinyl monomer at that time is preferable from the viewpoints of allowing swelling of the seed particles to proceed favorably, thereby promoting absorption of the vinyl monomer mixture to the seed particles, and obtaining polymer crosslinked microparticles that have been adequately crosslinked.

In the second polymerization step, in the case of producing crosslinked polymer microparticles by using polymer microparticles obtained according to the first polymerization step as seed particles, the proportions of seed particles and vinyl monomers including the crosslinked monomer (vinyl monomer mixture) used are preferably 0.5 parts by mass to 10 parts by mass and more preferably 0.7 parts by mass to 5 parts by mass of vinyl monomers (vinyl monomer mixture) based on 1 part by mass of seed particles. At that time, the proportion of polyfunctional vinyl monomer is preferably 3% by mass to 95% by mass and particularly preferably 5% by mass to 75% by mass based on the total mass of the vinyl monomer mixture.

In the case the above-mentioned polymer microparticles obtained by dispersion polymerization of the present invention are any of non-crosslinked polymer microparticles or crosslinked polymer microparticles, in general, the volume average particle diameter (dv) thereof is about 10 μm or less and preferably 0.7 μm to 3.0 μm, which results in the formation of extremely fine particles, and the value represented by (dv)/(dn) obtained by dividing the volume average particle diameter by the number average particle diameter is 1.2 or less, thereby indicating that the polymer microparticles have a narrow particle size distribution and uniform size.

In the polymer microparticles obtained in the present invention, the volume average particle diameter (dv) thereof is preferably 1.0 m to 2.5 m and more preferably 1.0 μm to 2.0 μm. In addition, the value of (dv)/(dn) is preferably 1.1 or less, thereby enabling the polymer microparticles to be smoothly produced according to the method of the present invention.

Here, the volume average particle diameter (dv) and number average particle diameter (dn) of the polymer microparticles as described in the present description can be measured by light scattering using a laser diffraction/scattering particle size distribution measuring apparatus. Measurement can be typically carried out using the laser diffraction/scattering particle size distribution meter disclosed in the examples (MT-3000, Nikkiso Co., Ltd.) or an apparatus having equal or better measurement accuracy.

In addition, the polymer microparticles described in the present description are such that the number of byproduct small particles per 1000 polymer microparticles having a particle diameter of 0.1 μm or more is preferably 500 or less. A number of byproduct small particles equal to or less than this number means that the polymer microparticles have a narrow molecular weight distribution, uniform size, and superior monodispersivity. Here, byproduct small particles refer to particles having a circle equivalent diameter of 0.5 μm or less.

In order to specify the above-mentioned number of byproduct small particles, five or more SEM images are acquired while changing the imaging location at a magnification factor at which 200 or more of the resulting polymer microparticles are captured in a single image by using a scanning electron microscope such as a field emission scanning electron microscope, measuring for these SEM images the particle diameter (circle equivalent diameter) for all particles having a particle diameter 0.1 μm or more that can be measured using image analysis software and the like, and calculating the number of particles having a particle diameter of 0.5 μm or less present per 1000 particles after having measured the particle diameter of 1000 or more particles.

The polymer microparticles obtained according to the dispersion polymerization method of the present invention have an extremely minute particle diameter on the micron order, have a narrow particle size distribution and uniform size, are monodispersive and do not demonstrate aggregation among particles, and demonstrate superior heat resistance, chemical resistance, strength or the like when in the form of crosslinked polymer microparticles. Thus, these polymer microparticles can be preferably used in various applications by taking advantage of these characteristics, examples of which include spacers for liquid crystal displays, light scattering film for liquid crystal displays, light scattering agents of diffusers or the like, electrically conductive microparticles, column fillers and supports for diagnostic drugs.

Based on the previous explanation, each of the above-mentioned embodiments can clearly be carried out in the form of polymer microparticles, dispersion stabilizer used to produce polymer microparticles, and a method for dispersing polymer microparticles.

### EXAMPLES

The following provides a detailed explanation of the present invention based on examples thereof. Furthermore, the present invention is not limited by these examples. Furthermore, the terms “parts” and “%” used in the following descriptions refer to parts by mass and percent (%) by mass unless specifically indicated otherwise.

1. Evaluation of Physical Properties

The methods used to measure or evaluate polymer weight average molecular weight (Mw) and number average molecular weight (Mn), addition rate of compound (α) to polymer (A), polymerization stability, volume average particle diameter (dv) and number average particle diameter (dn) of polymer microparticles, and the amount of byproduct small particles in the following examples are as indicated below.

1-1. Polymer Weight Average Molecular Weight (Mw) and Number Average Molecular Weight (Mn)

The weight average molecular weight (Mw) and number average molecular weight (Mn) of polymer (A), for example, were determined as polystyrene standard by gel permeation chromatography (GPC).

More specifically, measurements were carried out using the “HLC-8220GPC” (name of the model) manufactured by Tosoh Corporation for the GPC system and using four “TSK-Gel Multipore HXL-M (trade name)” columns for the chromatography columns. After dissolving the polymer in tetrahydrofuran (THF) to prepare a solution having a concentration of 0.2% by weight, 100 μL of the solution were injected into the columns followed by measuring using THF for the eluent at a column temperature of 40° C. and eluent (THF) flow rate of 1.0 mL/min. The measurement results were analyzed using a calibration curve prepared using polystyrene standards to determine weight average molecular weight (Mw) and number average molecular weight (Mn) as polystyrene.

In the case of measuring polymer (A), after isolating the polymer (A) by removing volatile matter from a dispersion thereof, the polymer (A) was dissolved in tetrahydrofuran followed by use of the resulting solution (concentration: 5 mg/ml).

In the case of measuring a polymer composition containing macromonomer (MM) (mixture composed of polymers), measurement was carried out according to the method indicated below. After having acidified the dispersion using a suitable amount of hydrochloric acid, volatile matter was removed. Next, non-volatile matter was recovered and washed with water. Subsequently, the water was removed and the entire amount of polymer including the macromonomer (MM) was dissolved in tetrahydrofuran followed by use of the resulting solution (concentration: 5 mg/ml).

1-2. Addition Rate of Compound (α) to Polymer (A)

The residual amount of compound (α) and the amount of side reaction products formed were measured by gas chromatography (GC) to determine the addition rate of compound (α) to polymer (A). Furthermore, glycidyl methacrylate was used for compound (α) in the following Production Examples 1 to 12.

More specifically, measurements were carried out by diluting the reaction solution with distilled water, adding an internal standard in the form of methyl cellosolve acetate to prepare measurement samples, using helium for the carrier gas, and raising the column temperature from 50° C. to 200° C. at the rate of 10° C./min using the “GC-2014” manufactured by Shimadzu Corporation for the GC system, using an FID detector, and using the CP-Wax 52CB column (60 m) manufactured by Varian Inc. for the column. The amount of unreacted residual glycidyl methacrylate and the amount of glycidyl methacrylate water adduct were quantified from the peak areas of glycidyl methacrylate and glycidyl methacrylate water adduct. The water addition rate of the glycidyl methacrylate was determined by dividing the amount of glycidyl methacrylate consumed by addition of water by the total amount of glycidyl methacrylate. In addition, the addition rate of glycidyl methacrylate to polymer (A) was determined by subtracting the amount of residual glycidyl methacrylate and the amount of glycidyl methacrylate consumed by addition of water from the total amount of glycidyl methacrylate used followed by dividing by the total amount of glycidyl methacrylate used.

1-3. Evaluation of Polymerization Stability

After removing the dispersion of polymer microparticles obtained by polymerization from the reactor, the inside of the reactor and the amount of polymer adhered to the stirring blades were observed visually followed by evaluating polymerization stability in accordance with the evaluation criteria indicated below. In addition, the dispersion of polymer microparticles removed from the reactor was filtered with a 200 mesh PolyNet filter (pore size: 114 μm) followed by measuring the dry weight of aggregates remaining on the PolyNet filter and measuring the amount of aggregates relative to the total charged amount.

[Polymerization Stability Evaluation Criteria]
∘: Aggregation not observed inside reactor or on stirring blades
Δ: Aggregates having a diameter of less than 1 cm present inside reactor or on stirring blades
x: Aggregates having a diameter of 1 cm or larger present inside reactor or on stirring blades

1-4. Volume Average Particle Diameter (dv) and Number Average Particle Diameter (dn) of Polymer Microparticles

A portion of the dispersion of polymer microparticles taken out of the reaction was sampled followed by adjusting the concentration to 5% by weight by adding methanol and shaking to mix well to uniformly disperse the sample. After irradiating with ultrasonic waves for 10 minutes using a laser diffraction/scattering particle size distribution meter (MT-3000, Nikkiso Co., Ltd.), particle size distribution was measured to obtain volume average particle diameter (dv) and number average particle diameter (dn). Ion exchange water was used for the circulating dispersion medium during measurement.

1-5. Byproduct Small Particles

After having removed volatile matter (such as polymerization solvent or residual monomer) from the resulting dispersion of polymer microparticles, the recovered polymer microparticles were observed with a field emission scanning electron microscope (FE-SEM, JEOL Ltd., JSM-6330F). Five or more SEM micrographs were captured while changing the imaging location at a magnification factor at which 200 or more of the resulting polymer microparticles are captured in a single image. These SEM images were then used to measure particle diameter (circle equivalent diameter) for all particles having a particle diameter 0.1 μm or more able to be measured for particle diameter followed by measurement of particle diameter for 1000 or more particles. Among the measured particles, the number of particles having a particle diameter of 0.5 μm or less present per 1000 particles was measured using WinROOF image analysis software (Mitani Corporation).

2. Production of Solution containing Dispersion Stabilizer

### Production Example 1 (Production of Dispersion (MM-1))

200 parts by mass of ion exchange water were charged into a glass reactor equipped with a stirrer, reflux condenser, thermometer, nitrogen inlet tube and liquid feed line connection. Moreover, 1.57 parts by mass of methyl methacrylate (hereinafter, MMA), 1.57 parts by mass of isobutyl methacrylate (hereinafter, IBMA), 1.5 parts by mass of methacrylic acid (hereinafter, MAA) and 0.36 parts by mass of 2-ethylhexyl thioglycolate (hereinafter, OTG) were further charged into the reactor (5 parts by mass) followed by adjusting the internal temperature of the reactor to 80° C. while stirring and blowing in nitrogen gas.

On the other hand, 29.8 parts by mass of MMA, 29.8 parts by mass of IBMA, 28.5 parts by mass of MAA and 6.9 parts by mass of OTG were charged into a glass reactor equipped with a liquid feed line with a quantitative pump, and stirred to prepare a monomer mixture (95 parts by mass).

After confirming that the internal temperature of the above-mentioned reactor had stabilized at 80° C., an aqueous polymerization initiator solution, obtained by dissolving 0.8 parts by mass of ammonium persulfate (polymerization initiator) in 3.0 parts by mass of ion exchange water, was added to the reactor. Next, supply of the above-mentioned monomer mixture to the reactor was started five minutes later using the quantitative pump and 95 parts by mass of the monomer mixture were supplied to the reactor at a constant rate over the course of 240 minutes. After having finished supplying the monomer mixture, the internal temperature of the reactor was raised to 90° C. over the course of 30 minutes after which the internal temperature was maintained for 4.5 hours to obtain a dispersion of the polymer (A) having carboxyl groups at an intermediate location in the molecular chain thereof (to also be referred as “Polymer (A-1)”). After having sampled a small amount of the dispersion and drying followed by measuring the sample by GPC, the weight average molecular weight (Mw) of the Polymer (A-1) was determined to be 4,900 and the number average molecular weight (Mn) was determined to be 2,800. In addition, the amount of carboxyl groups of the Polymer (A-1) was calculated from the monomer composition to be 3.49 meq/g.

Next, after lowering the temperature of the dispersion of the Polymer (A-1) in the above-mentioned reactor to 80° C. over the course of 30 minutes, air was blown in instead of nitrogen gas followed by immediate addition of 0.03 parts by mass of methoxyhydroquinone. Five minutes after having added the methoxyhydroquinone, 14.1 parts by mass of triethylamine (hereinafter, TEA) were supplied to the reactors at a constant rate over the course of 30 minutes. Fifteen minutes later, 10.15 parts by mass of glycidyl methacrylate (hereinafter, GMA) were supplied to the reactor at a constant rate over the course of 30 minutes followed by heating the reactor at an internal temperature of 80° C. for 3 hours to add the GMA to react with a portion of the carboxyl groups of the Polymer (A-1) and produce a dispersion of a polymer composition containing a macromonomer having methacryloyl groups (mixture composed of monomers). This polymer composition is subsequently referred to as “Polymer Composition (MM-1)”. Ion exchange water was then added to the dispersion of the Polymer Composition (MM-1) and the solid content was adjusted to 30% by mass to obtain Dispersion (MM-1).

Subsequently, a portion of the Dispersion (MM-1) containing macromonomer obtained in the manner described above was sampled and subjected to GC analysis according to the previously described method. GMA was not detected as a result of measurement. In addition, a GMA water adduct equivalent to 7% of the GMA was detected. According to this result, the addition rate of GMA to Polymer (A-1) was calculated to be 93% and the water addition rate was calculated to be 7%. Thus, the Polymer Composition (MM-1) was determined to have on average 1.86 ethylenically unsaturated groups (f value) per molecule (per single polymer chain) according to the calculation described below using the number average molecular weight (Mn) of the Polymer (A-1) and the addition rate of GMA to the Polymer (A-1).

The average amount of ethylenically unsaturated groups introduced in the Polymer Composition (MM-1) obtained in the manner described above (f value) and the average value of the carboxyl group content thereof were determined according to the calculations indicated below.

[Calculation of Average Amount of Ethylenically Unsaturated Groups Introduced in Plymer Composition (f Value)]

The number of moles of 100 parts of the Polymer (A-1) is 100/2800 by using the Mn of Polymer (A-1) (2800).

0.93×10.15 parts of glycidyl methacrylate are added to 100 parts of the Polymer (A-1).

The number of moles of glycidyl methacrylate added based on the molecular weight of glycidyl methacrylate (142) is (10.15 parts×0.93)/142. Thus,

$$\begin{matrix}\begin{matrix}X = amount of carboxyl groups per 100 \\ parts by mass of polymer ( A - 1 ) \\ = 349 ( meq ) ;\end{matrix} & \\ \begin{matrix}Y = \{ \begin{matrix}charged amount of glycidyl methacrylate \\ per 100 parts by mass of polymer\end{matrix} \} \times \\ \{ \begin{matrix}addition rate of glycidyl methacrylate \\ to polymer ( A - 1 )\end{matrix} \} \\ = 10.15 \times 0.93 ; \\ = 9.44 parts by mass ( \begin{matrix}amount of glycidyl methacrylate \\ \begin{matrix}( parts by mass ) added to 100 parts \\ by mass of Polymer ( A - 1 )\end{matrix}\end{matrix} ) ;\end{matrix} & \\ and , & \\ \begin{matrix}Z = \{ Y / molecular weight of glycidyl methacrylate \} \times 1000 \\ = ( 9.44 / 142 ) \times 1000 \\ = 66.5 ( meq ) ( \begin{matrix}amount of glycidyl methacrylate ( meq ) \\ \begin{matrix}added to 100 parts \\ by mass of Polymer ( A - 1 )\end{matrix}\end{matrix} ) ,\end{matrix} & \\ D = 2.58 meq \text{/} g . & \end{matrix}$$

[Calculation of Average Value of Carboxyl Group Content in Polymer Composition (meq/g)]

The average value (D) of the carboxyl group content in the polymer composition was determined in accordance with the previously described Equation (1).

More specifically, since:

$$\begin{matrix}f value = \frac{\{ number of moles of glycidyl methacrylate added \}}{\{ number of moles of Polymer ( A - 1 ) \}} \\ = \frac{( 10.15 \times 0.93 / 142 )}{( 100 / 2800 )} \\ = 1.86 .\end{matrix}$$

Furthermore, the average amount of ethylenically unsaturated groups introduced into the polymer compositions of Examples 2 to 17 (f value) and the carboxyl group content thereof were also determined in the same manner as described above.

### Examples 2 to 15 (Production of Dispersions (MM2 to MM15))

Dispersions of Polymers (A-2) to (A-15) having carboxyl groups at an intermediate location in the molecular chains thereof were produced by carrying out the same procedure as Production Example 1 using monomers having the compositions shown in the following Tables 1 and 2. After having sampled and dried a small amount of each dispersion and measuring by GPC using the previously described method, the weight average molecular weights (Mw) and number average molecular weights (Mn) of the Polymers (A-2) to (A-15) were as shown in Tables 1 and 2. In addition, the amounts of carboxyl groups of the Polymers (A-2) to (A-15) were as shown in Tables 1 and 2 based on the monomer compositions thereof.

TEA and GMA were added in the amounts shown in Tables 1 and 2 to the dispersions of Polymers (A-2) to (A-15) obtained in the manner described above followed by adding GMA to a portion of the carboxyl groups of Polymers (A-2) to (A-15) in the same manner as Production Example 1 to obtain dispersions of polymer compositions containing macromonomer (Polymer Compositions (MM-2) to (MM-15)). Ion exchange water was then added to the dispersions of Polymer Compositions (MM-2 to MM-15) to adjust the solid contents thereof to 30% by mass and obtain Dispersions (MM-2 to MM-15).

Subsequently, portions of the dispersions containing the Polymer Compositions (MM-2) to (MM-15) obtained in the manner described above were sampled and analyzed by GC according to the method described above. GMA was not detected in any of the dispersions as a result of measurement. In addition, after measuring the amount of GMA water adduct, the average number of ethylenically unsaturated groups per molecule (per polymer chain) of the Polymer Compositions (MM-2) to (MM-15) (average amount of ethylenically unsaturated groups introduced (f value)) was determined in the same manner as Production Example 1 and shown in Tables 1 and 2.

### Production Example 16 (Production of Dispersion (MM-16))

200 parts by mass of ion exchange water were charged into a glass reactor equipped with a stirrer, reflux condenser, thermometer, nitrogen inlet tube and liquid feed line connection followed by adjusting the internal temperature of the reactor to 80° C. while stirring and blowing in nitrogen gas.

On the other hand, 36.4 parts by mass of MMA, 36.4 parts by mass of IBMA, 20.0 parts by mass of MAA and 7.3 parts by mass of OTG were charged into a glass reactor equipped with a liquid feed line with a quantitative pump, and stirred to prepare a monomer mixture (100 parts by mass).

After confining that the internal temperature of the above-mentioned reactor had stabilized at 80° C., an aqueous polymerization initiator solution, obtained by dissolving 0.8 parts by mass of ammonium persulfate (polymerization initiator) in 3.0 parts by mass of ion exchange water, was added to the reactor Next, supply of the above-mentioned monomer mixture to the reactor was started five minutes later using the quantitative pump and 100 parts by mass of the monomer mixture were supplied to the reactor at a constant rate over the course of 240 minutes. After having finished supplying the monomer mixture, the internal temperature of the reactor was raised to 90° C. over the course of 30 minutes after which the internal temperature was maintained for 4.5 hours to obtain a dispersion of the Polymer (A-16) having carboxyl groups at an intermediate location in the molecular chain thereof. After having sampled a small amount of the dispersion and drying followed by measuring the sample by GPC according to the previously described method, the weight average molecular weight (Mw) and the number average molecular weight (Mn) of the Polymer (A-16) were as shown in Table 2. In addition, the amount of carboxyl groups of the Polymer (A-16) was as shown in Table 2 based on the monomer composition.

TEA and GMA were added in the amounts shown in Table 2 to the dispersion of the Polymer (A-16) obtained in the manner described above followed by adding GMA to a portion of the carboxyl groups of the Polymer (A-16) in the same manner as Production Example 1 to obtain a dispersion of a polymer composition containing macromonomer (Polymer Composition (MM-16)). Ion exchange water as then added to the dispersion of Polymer Compositions (MM-16) to adjust the solid content thereof to 30% by mass and obtain Dispersion (MM-16).

Subsequently, a portion of the dispersion containing the Polymer Composition (MM-16) obtained in the manner described above was sampled and analyzed by GC according to the method described above. GMA was not detected in the dispersion as a result of measurement. In addition, after measuring the amount of GMA water adduct, the average number of ethylenically unsaturated groups per molecule (per polymer chain) of the Polymer Composition (MM-16) (average amount of ethylenically unsaturated groups introduced (f value)) was determined in the same manner as Production Example 1 and shown in Table 2.

Production Example 17 (Production of Dispersion (MM-17)) 200 parts by mass of ion exchange water were charged into a glass reactor equipped with a stirrer, reflux condenser, thermometer, nitrogen inlet tube and liquid feed line connection.

Moreover, 1.57 parts by mass of MMA, 1.57 parts by mass of IBMA and 1.5 parts by mass of metacrylic acid MAA were charged (4.64 parts by mass) into the reactor followed by adjusting the internal temperature of the reactor to 80° C. while stirring and blowing in nitrogen gas.

On the other hand, 29.8 parts by mass of MMA, 29.8 parts by mass of IBMA, 28.5 parts by mass of MAA and 7.26 parts by mass of OTG were charged into a glass reactor equipped with a liquid feed line with a quantitative pump, and stirred to prepare a monomer mixture (95.36 parts by mass).

After confirming that the internal temperature of the above-mentioned reactor had stabilized at 80° C., an aqueous polymerization initiator solution, obtained by dissolving 0.8 parts by mass of ammonium persulfate (polymerization initiator) in 3.0 parts by mass of ion exchange water, was added to the reactor. Next, supply of the above-mentioned monomer mixture to the reactor was started five minutes later using the quantitative pump and 95.36 parts by mass of the monomer mixture were supplied to the reactor at a constant rate over the course of 240 minutes.

After having finished supplying the monomer mixture, the internal temperature of the reactor was raised to 90° C. over the course of 30 minutes after which the internal temperature was maintained for 4.5 hours to obtain a dispersion of the Polymer (A-17) having carboxyl groups at an intermediate location in the molecular chain thereof. After having sampled a small amount of the dispersion and drying followed by measuring the sample by GPC according to the previously described method, the weight average molecular weight (Mw) and the number average molecular weight (Mn) of the Polymer (A-17) were as shown in Table 2. In addition, the amount of carboxyl groups of the Polymer (A-17) was as shown in Table 2 based on the monomer composition.

TEA and GMA were added in the amounts shown in Table 2 to the dispersion of the Polymer (A-17) obtained in the manner described above followed by adding GMA to a portion of the carboxyl groups of the Polymer (A-17) in the same manner as Production Example 1 to obtain a dispersion of a polymer composition containing macromonomer (Polymer Composition (MM-17)). Ion exchange water as then added to the dispersion of Polymer Compositions (MM-17) to adjust the solid content thereof to 30% by mass and obtain Dispersion (MM-17).

Subsequently, a portion of the dispersion containing the Polymer Composition (MM-17) obtained in the manner described above was sampled and analyzed by GC according to the method described above. No GMA was detected in the dispersions as a result of measurement. In addition, after measuring the amount of GMA water adduct, the average number of ethylenically unsaturated groups per molecule (per polymer chain) of the Polymer Composition (MM-17) (average amount of ethylenically unsaturated groups introduced (f value)) was determined in the same manner as Production Example 1 and shown in Table 2.

TABLE 1

| | | Prod. | Prod. | Prod. | Prod. | Prod. | Prod. | Prod. | Prod. | Prod. | Prod. |
|---|---|---|---|---|---|---|---|---|---|---|---|
| Dispersion | | Ex. 1 | Ex. 2 | Ex. 3 | Ex. 4 | Ex. 5 | Ex. 6 | Ex. 7 | Ex. 8 | Ex. 9 | Ex. 10 |
| Stabilizer Dispersion | | MM-1 | MM-2 | MM-3 | MM-4 | MM-5 | MM-6 | MM-7 | MM-8 | MM-9 | MM-10 |
| Monomer | MMA | 31.4 | 33.9 | 35.1 | 36.4 | 38.1 | 39.9 | 41.4 | 36.4 | 36.4 | 36.4 |
| Mixture | IBMA | 31.4 | 33.9 | 35.1 | 36.4 | 38.1 | 39.9 | 41.4 | 36.4 | 36.4 | 36.4 |
| Composition | MAA | 30.0 | 25.0 | 22.5 | 20.0 | 16.5 | 13.0 | 10.0 | 20.0 | 20.0 | 20.0 |
| (parts | OTG | 7.3 | 7.3 | 7.3 | 7.3 | 7.3 | 7.3 | 7.3 | 7.3 | 7.3 | 7.3 |
| by mass) | Supply | a) | a) | a) | a) | a) | a) | a) | a) | a) | a) |
| | Method | | | | | | | | | | |
| Polymer (A) | Type | A-1 | A-2 | A-3 | A-4 | A-5 | A-6 | A-7 | A-8 | A-9 | A-10 |
| | Mn (g/mol) | 2,800 | 2,900 | 2,800 | 2,800 | 2,700 | 2,700 | 2,900 | 2,800 | 2,800 | 2,800 |
| | Mw (g/mol) | 4,900 | 5,100 | 4,800 | 4,800 | 4,800 | 4,700 | 5,000 | 4,800 | 4,900 | 4,800 |
| | COOH | 3.49 | 2.91 | 2.62 | 2.33 | 1.92 | 1.51 | 1.16 | 2.33 | 2.33 | 2.33 |
| | groups | | | | | | | | | | |
| | (meq/g) | | | | | | | | | | |
| Addition | TEA | 14.1 | 11.7 | 10.6 | 9.4 | 7.8 | 6.1 | 4.7 | 9.4 | 9.4 | 9.4 |
| Reaction | GMA | 10.15 | 10.15 | 10.15 | 10.15 | 10.15 | 10.15 | 10.15 | 15.22 | 12.69 | 8.12 |
| (parts by | | | | | | | | | | | |
| mass) | | | | | | | | | | | |
| GMA | Water | 0.07 | 0.08 | 0.09 | 0.06 | 0.08 | 0.08 | 0.08 | 0.10 | 0.09 | 0.06 |
| Addition | addition rate | | | | | | | | | | |
| Reaction | Addition | 0.93 | 0.92 | 0.91 | 0.94 | 0.92 | 0.92 | 0.92 | 0.90 | 0.91 | 0.94 |
| Rate | rate to | | | | | | | | | | |
| | polymer (A) | | | | | | | | | | |
| Dispersion | f value | 1.86 | 1.91 | 1.82 | 1.88 | 1.78 | 1.77 | 1.91 | 2.70 | 2.28 | 1.50 |
| Stabilizer | COOH | 2.58 | 2.06 | 1.80 | 1.51 | 1.15 | 0.78 | 0.46 | 1.20 | 1.36 | 1.66 |
| | groups | | | | | | | | | | |
| | (meq/g) | | | | | | | | | | |
| | Mn (g/mol) | 3,100 | 3,200 | 3,100 | 3,100 | 3,000 | 3,000 | 3,200 | 3,200 | 3,100 | 3,000 |
| | Mw (g/mol) | 5,400 | 5,600 | 5,200 | 5,300 | 5,200 | 5,100 | 5,500 | 5,500 | 5,500 | 5,200 |
| | Mw/Mn | 1.74 | 1.75 | 1.68 | 1.71 | 1.73 | 1.70 | 1.72 | 1.72 | 1.77 | 1.73 |

Monomer Supply Method:
a) Initial charging of amount equivalent to 5% of monomer mixture and chain transfer agent
b) Monomer mixture not initially charged
c) Initial charging of amount equivalent to 5% of monomer mixture only

TABLE 2

| | | Prod. | Prod. | Prod. | Prod. | Prod. | Prod. | Prod. |
|---|---|---|---|---|---|---|---|---|
| Dispersion | | Ex. 11 | Ex. 12 | Ex. 13 | Ex. 14 | Ex. 15 | Ex. 16 | Ex. 17 |
| Stabilizer Dispersion | | MM-11 | MM-12 | MM-13 | MM-14 | MM-15 | MM-16 | MM-17 |
| Monomer Mixture | MMA | 36.4 | 38.2 | 30.7 | 72.7 | | 36.4 | 36.4 |
| Composition (parts | IBMA | 36.4 | 38.2 | 30.7 | | 72.7 | 36.4 | 36.4 |
| by mass) | MAA | 20.0 | 20.0 | 25.0 | 20.0 | 20.0 | 20.0 | 20.0 |
| | OTG | 7.3 | 3.6 | 13.6 | 7.3 | 7.3 | 7.3 | 7.3 |
| | Supply Method | a) | a) | a) | a) | a) | b) | c) |
| Polymer (A) | Type | A-11 | A-12 | A-13 | A-14 | A-15 | A-16 | A-17 |
| | Mn (g/mol) | 2,700 | 5,600 | 1,500 | 2,700 | 2,800 | 2,900 | 2,900 |
| | Mw (g/mol) | 4,800 | 10,100 | 2,600 | 4,700 | 4,900 | 6,500 | 8,100 |
| | COOH groups | 2.33 | 2.33 | 2.91 | 2.33 | 2.33 | 2.33 | 2.33 |
| | (meq/g) | | | | | | | |
| Addition Reaction | TEA | 9.4 | 9.4 | 11.7 | 9.4 | 9.4 | 9.4 | 9.4 |
| (parts by mass) | GMA | 6.09 | 5.01 | 18.93 | 10.15 | 10.15 | 10.15 | 10.15 |
| GMA Addition | Water addition rate | 0.04 | 0.05 | 0.06 | 0.09 | 0.07 | 0.10 | 0.09 |
| Reaction Rate | Addition rate to | 0.96 | 0.95 | 0.94 | 0.91 | 0.93 | 0.90 | 0.91 |
| | polymer (A) | | | | | | | |
| Dispersion | f value | 1.11 | 1.88 | 1.88 | 1.76 | 1.86 | 1.87 | 1.89 |
| Stabilizer | COOH groups | 1.81 | 1.90 | 1.40 | 1.53 | 1.52 | 1.54 | 1.53 |
| | (meq/g) | | | | | | | |
| | Mn (g/mol) | 2,900 | 5,900 | 1,800 | 2,900 | 3,100 | 3,200 | 3,200 |
| | mw (g/mol) | 5,100 | 10,600 | 3,100 | 5,100 | 5,400 | 7,100 | 8,800 |
| | Mw/Mn | 1.76 | 1.80 | 1.72 | 1.76 | 1.74 | 2.22 | 2.75 |

Monomer Supply Method:
a) Initial charging of amount equivalent to 5% of monomer mixture and chain transfer agent
b) Monomer mixture not initially charged
c) Initial charging of amount equivalent to 5% of monomer mixture only

3. Production of Polymer Microparticles (1)

### Example 1 (Production of Polymer Microparticles (PA-1))

98.6 parts by mass ion exchange water, 255.6 parts by mass of methanol, 0.12 parts by mass of 25% aqueous ammonia, 8.33 parts by mass (equivalent to solid content of 2.5 parts by mass) of the dispersion (MM-2) containing the polymer composition (dispersion stabilizer) produced in Production Example 2, 50 parts by mass of MMA and 50 parts by mass of IBMA were charged into a glass reactor equipped with a stirrer, reflux condenser, thermometer, nitrogen inlet tube and liquid feed line connection followed by adjusting the internal temperature of the reactor to 55° C. while stirring and feeding nitrogen gas.

After confirming that the internal temperature of the above-mentioned reactor had stabilized at 55° C., 2.4 parts by mass of a polymerization initiator in the form of a 70% solution of t-butylperoxypivalate (trade name: Perbutyl PV, NOF Corporation) were added to the reactor to initiate polymerization. The reaction solution became cloudy immediately after the addition of polymerization initiator and gradually became white resulting in a milky white color, thereby confirming the formation of polymer microparticles (to be referred to as “Polymer Microparticles (PA-1)”).

Following addition of the above-mentioned polymerization initiator, the reaction solution was cooled at the point 240 minutes had elapsed to terminate polymerization. The polymerization reaction solution was then passed through a 200 mesh PolyNet filter to recover the dispersion of Polymer Microparticles (PA-1). Polymer was not adhered to the inside of the reactor or stirring blades after having extracted the polymerization reaction solution and filtration residue was not observed on the 200 mesh PolyNet filter.

A portion of the recovered dispersion was diluted to 5% with methanol followed by irradiating with ultrasonic waves for 10 minutes and measuring particle diameter using a laser diffraction/scattering particle size distribution meter. The resulting particle size distribution was monophasic, and the volume average particle diameter (dv) and number average particle diameter (dn) were 1.07 μm and 1.03 μm, respectively.

### Examples 2 to 13 (Production of Polymer Microparticles (PA-2) to (PA-13))

Dispersions of polymer microparticles (to be referred to as “Polymer Microparticles (PA-2) to (PA-13)”) were produced in the same manner as Example 1 with the exception of changing the type of dispersion and the amounts of water and methanol used as solvents to those shown in Tables 3 and 4. Evaluation of polymerization stability carried out in the same manner as Example 1 yielded the results shown in Tables 3 and 4.

Furthermore, in the previously described Example 1 and all of Examples 2 to 13, the ratio of solvent (methanol, water or 25% aqueous ammonia) to monomer was adjusted to be such that solvent/monomer=360/100 (monomer concentration: approx. 22%). In addition, the amount of water used was adjusted so that the volume average particle diameter of the resulting polymer microparticles was equal within the range of about 1.0 μm to 1.2 μm.

### Comparative Examples 1 to 5 (Production of Polymer Microparticles (PB-1 to PB-5))

Dispersions of polymer microparticles (to be referred to as “Polymer Microparticles (PB-1) to (PB-5)”) were produced in the same manner as Example 1 with the exception of changing the type and amount of dispersion and the amounts of water and methanol used as solvents to those shown in Table 5. Evaluation of polymerization stability carried out in the same manner as Example 1 yielded the results shown in Table 5.

Here, polymerization was discontinued in Comparative Examples 2 and 5 since large amounts of aggregates formed within 1 hour after adding polymerization initiator making stirring difficult. Consequently, Polymer Microparticles PB-2 and PB-5 were unable to be obtained.

TABLE 3

| | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|
| Polymer Microparticles | | PA-1 | PA-2 | PA-3 | PA-4 | PA-5 | PA-6 | PA-7 | PA-8 | PA-9 |
| Dispersion | Type | MM-2 | MM-3 | MM-4 | MM-5 | MM-6 | MM-9 | MM-10 | MM-12 | MM-13 |
| Stabilizer | Charged amt. | 8.33 | 8.33 | 8.33 | 8.33 | 8.33 | 8.33 | 8.33 | 8.33 | 8.33 |
| Dispersion | (parts by mass) | | | | | | | | | |
| | (As solid) | 2.50 | 2.50 | 2.50 | 2.50 | 2.50 | 2.50 | 2.50 | 2.50 | 2.50 |
| 25% aqueous ammonia | | 0.12 | 0.12 | 0.12 | 0.12 | 0.12 | 0.12 | 0.12 | 0.12 | 0.12 |
| (parts by mass) | | | | | | | | | | |
| Solvent | Water | 98.6 | 98.6 | 98.6 | 98.6 | 98.6 | 91.4 | 102.2 | 95.0 | 98.6 |
| (parts by mass) | MeOH | 255.6 | 255.6 | 255.6 | 255.6 | 255.6 | 262.8 | 252.0 | 259.2 | 255.6 |
| Monomer | MMA | 50.0 | 50.0 | 50.0 | 50.0 | 50.0 | 50.0 | 50.0 | 50.0 | 50.0 |
| (parts by mass) | IBMA | 50.0 | 50.0 | 50.0 | 50.0 | 50.0 | 50.0 | 50.0 | 50.0 | 50.0 |
| Polymerization Stability | | ∘ | ∘ | ∘ | ∘ | Δ | ∘ | Δ | ∘ | Δ |
| Aggregates (ppm) | | 0 | 4 | 0 | 56 | 340 | 0 | 560 | 10 | 167 |
| Polymer | dv (μm) | 1.07 | 1.10 | 1.12 | 1.13 | 1.15 | 1.09 | 1.15 | 1.06 | 1.13 |
| Microparticles | dn (μm) | 1.03 | 1.05 | 1.08 | 1.09 | 1.10 | 1.04 | 1.09 | 1.01 | 1.09 |
| | dv/dn | 1.04 | 1.05 | 1.04 | 1.04 | 1.05 | 1.05 | 1.06 | 1.05 | 1.04 |
| | Byproduct small | 143 | 53 | 27 | 12 | 14 | 86 | 17 | 185 | 36 |
| | particles (per | | | | | | | | | |
| | 1000 particles) | | | | | | | | | |

TABLE 4

| | | Ex. 10 | Ex. 11 | Ex. 12 | Ex. 13 |
|---|---|---|---|---|---|
| Polymer Microparticles | | PA-10 | PA-11 | PA-12 | PA-13 |
| Dispersion | Type | MM-14 | MM-15 | MM-16 | MM-17 |
| Stabilizer | Charged amt. | 8.33 | 8.33 | 8.33 | 8.33 |
| Dispersion | (parts by mass) | | | | |
| | (As solid) | 2.50 | 2.50 | 2.50 | 2.50 |
| 25% aqueous ammonia | | 0.12 | 0.12 | 0.12 | 0.12 |
| (parts by mass) | | | | | |
| Solvent | Water | 98.6 | 98.6 | 98.6 | 98.6 |
| (parts by mass) | MeOH | 255.6 | 255.6 | 255.6 | 255.6 |
| Monomer | MMA | 50.0 | 50.0 | 50.0 | 50.0 |
| (parts by mass) | IBMA | 50.0 | 50.0 | 50.0 | 50.0 |
| Polymerization Stability | | ◯ | ◯ | ◯ | ◯ |
| Aggregates (ppm) | | 32 | 8 | 0 | 15 |
| Polymer | dv (μm) | 1.13 | 1.10 | 1.11 | 1.13 |
| Microparticles | dn (μm) | 1.08 | 1.07 | 1.05 | 1.06 |
| | dv/dn | 1.05 | 1.03 | 1.06 | 1.07 |
| | Byproduct small | 34 | 19 | 45 | 123 |
| | particles (per | | | | |
| | 1000 particles) | | | | |

TABLE 5

| | | Comp. Ex. 1 | Comp. Ex. 2 | Comp. Ex. 3 | Comp. Ex. 4 | Comp. Ex. 5 |
|---|---|---|---|---|---|---|
| Polymer Microparticles | | PB-1 | PB-2 | PB-3 | PB-4 | PB-5 |
| Dispersion | Type | MM-1 | MM-7 | MM-8 | MM-11 | PVP |
| Stabilizer | Charged amt. | 8.33 | 8.33 | 8.33 | 8.33 | 2.50 |
| Dispersion | (parts by mass) | | | | | |
| | (As solid) | 2.50 | 2.50 | 2.50 | 2.50 | 2.50 |
| 25% aqueous ammonia | | 0.12 | 0.12 | 0.12 | 0.12 | |
| (parts by mass) | | | | | | |
| Solvent | Water | 98.6 | 98.6 | 84.2 | 109.4 | 104.4 |
| (parts by mass) | MeOH | 255.6 | 255.6 | 270.0 | 244.8 | 255.6 |
| Monomer | MMA | 50.0 | 50.0 | 50.0 | 50.0 | 50.0 |
| (parts by mass) | IBMA | 50.0 | 50.0 | 50.0 | 50.0 | 50.0 |
| Polymerization Stability | | ∘ | Polymerization | ∘ | x | Polymerization |
| Aggregates (ppm) | | 4 | discontinued due | 0 | 3760 | discontinued due |
| Polymer | dv (μm) | 1.04 | to large amount | 1.07 | 1.20 | to large amount |
| Microparticles | dn (μm) | 1.00 | of aggregate | 1.01 | 1.12 | of aggregate |
| | dv/dn | 1.04 | formation | 1.06 | 1.07 | formation |
| | Byproduct small | 878 | | 723 | 10 | |
| | particles (per 1000 | | | | | |
| | particles) | | | | | |

Details of the compounds used in Tables 1 to 5 are as indicated below.

MMA: Methyl methacrylate

IBMA: Isobutyl methacrylate

MAA: Methacrylic acid

OTG: 2-ethylhexyl thioglycolate

TEA: Triethylamine

GMA: Glycidyl methacrylate

MeOH: Methanol

Examples 1 to 13 are examples of having carried out dispersion polymerization of vinyl monomers (methyl methacrylate and isobutyl methacrylate) in a hydrophilic solvent using Polymer Compositions (MM-2) to (MM-6), (MM-9), (MM-10) and (MM-12) to (MM-17) containing dispersion stabilizers in the form of macromonomers having carboxyl groups and ethylenically unsaturated within the ranges defined in the present invention at an intermediate location of the molecular chain. Polymer microparticles having an extremely small particle diameter in terms of volume average particle diameter (dv) of 1.07 μm to 1.15 μm were smoothly obtained over a narrow particle size distribution with favorable polymerization stability without causing the formation of aggregates or the like among the polymer microparticles while only using an extremely small amount of dispersion stabilizer.

In contrast, Comparative Example 1 is an example of the use of Polymer Composition (MM-1) having a large amount of carboxyl groups at 2.58 meq/g as dispersion stabilizer. In addition, Comparative Example 3 is an example of the use of Polymer Composition (MM-8) having a large average amount of ethylenically unsaturated groups introduced therein at 2.70 as dispersion stabilizer. In these examples, results were obtained in which was observed the secondary production of an extremely large number of small particles. Here, the values for the ratio of dv/dn in Comparative Examples 1 and 3 are not high at 1.04 and 1.06, respectively. This is due to light scattering of small particles being weak in the case of measurement of particle diameter by laser diffraction, thereby resulting in the contribution of these particles being ignored.

Comparative Example 4 is an example of the use of Polymer Composition (MM-11) having a small amount of ethylenically unsaturated groups introduced therein at 1.11. Adequate polymerization stability is unable to be imparted under conditions in which monomer concentration exceeds 20%, and results were obtained in which a large amount of aggregates were formed.

In addition, in Comparative Example 5, commonly used polyvinylpyrrolidone (PVP, K-30, Wako Pure Chemical Industries, Ltd.) was used as dispersant for dispersion polymerization in a hydrophilic solvent. In the case of using at a solid content of 2.5 parts equal to that of the macromonomer-based dispersants, polymerization stability was inadequate and functions as a dispersion stabilizer were considerably inferior.

### INDUSTRIAL APPLICABILITY

The present invention is a method for producing polymer microparticles by dispersion polymerization using as dispersion stabilizer a macromonomer (Ma) having specific amounts of carboxyl groups and ethylenically unsaturated groups in the molecular chain thereof. As a result, non-crosslinked polymer microparticles or crosslinked polymer microparticles, having an extremely small particle diameter on the micron order, having a narrow particle size distribution and uniform particle diameter and demonstrating monodispersivity without undergoing aggregation among the organic microparticles, can be produced smoothly and with favorable productivity. In particular, crosslinked polymer microparticles obtained according to the method of the present invention have superior heat resistance, solvent resistance, chemical resistance, strength or the like. Consequently, polymer microparticles obtained according to the method of the present invention can be effectively used in various applications by taking advantage of these characteristics, examples of which include spacers for liquid crystal displays, light scattering film for liquid crystal displays, light scattering agents of diffusers, AG agents such as AG films for liquid crystal displays, anti-blocking agents for various types of films, electrically conductive microparticles, column fillers and supports for diagnostic drugs.

1. A method for producing polymer microparticles,
the method comprising:
producing the polymer microparticles by polymerizing vinyl monomers in a hydrophilic solvent, which dissolves the vinyl monomers and a dispersion stabilizer but does not dissolve a polymer formed, in the presence of the dispersion stabilizer; wherein
the dispersion stabilizer contains a macromonomer having carboxyl groups and ethylenically unsaturated groups at an intermediate location in a molecular chain thereof,
the macromonomer has, on average, 1.4 to 2.5 ethylenically unsaturated groups per molecule, and
an average value of a carboxyl group content in the macromonomer is 0.5 meq/g to 2.5 meq/g.

2. The method for producing polymer microparticles according to claim 1, wherein the macromonomer contains a (meth)acryloyl group.

3. The method for producing polymer microparticles according to claim 1, wherein the number average molecular weight (Mn) of the macromonomer is 1000 g/mol to 10000 g/mol.

4. The method for producing polymer microparticles according to claim 1, wherein a value (Mw/Mn) obtained by dividing a weight average molecular weight (Mw) by the number average molecular weight (Mn) of the macromonomer is 2.3 or less.

5. A polymer microparticle obtained with the production method according to claim 1, wherein
a volume average particle diameter thereof is 0.7 μm to 3.0 μm,
a value of volume average particle diameter (dv)/number average particle diameter (dn) is 1.2 or less, and
the number of byproduct small particles per 1000 polymer microparticles each having a particle diameter of 0.1 μm or more is 500 or less.

6. A polymer microparticle, which retains a macromonomer having carboxyl groups and ethylenically unsaturated groups at an intermediate location in a molecular chain thereof, wherein
the macromonomer has, on average, 1.4 to 2.5 ethylenically unsaturated groups per molecule, and
an average value of a carboxyl group content in the macromonomer is 0.5 meq/g to 2.5 meq/g.

7. The polymer microparticle according to claim 6, wherein the volume average particle diameter is 0.7 μm to 3.0 μm, a value of volume average particle diameter (dv)/number average particle diameter (dn) is 1.2 or less, and the number of byproduct small particles per 1000 polymer microparticles each having a particle diameter of 0.1 μm or more is 500 or less.

8. The polymer microparticle according to claim 6, wherein the macromonomer is provided with the ethylenically unsaturated groups through a portion of the carboxyl groups at an intermediate location of the molecular chain thereof.

9. A dispersion stabilizer used to produce polymer microparticles,
the dispersion stabilizer containing a macromonomer having carboxyl groups and ethylenically unsaturated groups at an intermediate location of the molecular chain thereof, wherein
the macromonomer has, on average, 1.4 to 2.5 ethylenically unsaturated groups per molecule, and
an average value of a carboxyl group content in the macromonomer is 0.5 meq/g to 2.5 meq/g.

10. A method for dispersing polymer microparticles,
the method comprising:
dispersing a polymer in the form of microparticles by polymerizing vinyl monomers in the presence of the dispersion stabilizer according to claim 9 in a hydrophilic solvent that dissolves the vinyl monomers and the dispersion stabilizer but does not dissolve the polymer formed.

11. The method for producing polymer microparticles according to claim 2, wherein the number average molecular weight (Mn) of the macromonomer is 1000 g/mol to 10000 g/mol.

12. The method for producing polymer microparticles according to claim 2, wherein a value (Mw/Mn) obtained by dividing a weight average molecular weight (Mw) by the number average molecular weight (Mn) of the macromonomer is 2.3 or less.

13. The method for producing polymer microparticles according to claim 3, wherein a value (Mw/Mn) obtained by dividing a weight average molecular weight (Mw) by the number average molecular weight (Mn) of the macromonomer is 2.3 or less.

14. A polymer microparticle obtained with the production method according to claim 2, wherein
a volume average particle diameter thereof is 0.7 μm to 3.0 μm,
a value of volume average particle diameter (dv)/number average particle diameter (dn) is 1.2 or less, and
the number of byproduct small particles per 1000 polymer microparticles each having a particle diameter of 0.1 μm or more is 500 or less.

15. A polymer microparticle obtained with the production method according to claim 3, wherein
a volume average particle diameter thereof is 0.7 μm to 3.0 μm,
a value of volume average particle diameter (dv)/number average particle diameter (dn) is 1.2 or less, and
the number of byproduct small particles per 1000 polymer microparticles each having a particle diameter of 0.1 μm or more is 500 or less.

16. A polymer microparticle obtained with the production method according to claim 4, wherein
a volume average particle diameter thereof is 0.7 μm to 3.0 μm,
a value of volume average particle diameter (dv)/number average particle diameter (dn) is 1.2 or less, and
the number of byproduct small particles per 1000 polymer microparticles each having a particle diameter of 0.1 μm or more is 500 or less.

17. The polymer microparticle according to claim 7, wherein the macromonomer is provided with the ethylenically unsaturated groups through a portion of the carboxyl groups at an intermediate location of the molecular chain thereof.

18. The method for producing polymer microparticles according to claim 11, wherein a value (Mw/Mn) obtained by dividing a weight average molecular weight (Mw) by the number average molecular weight (Mn) of the macromonomer is 2.3 or less.

19. A polymer microparticle obtained with the production method according to claim 12, wherein
a volume average particle diameter thereof is 0.7 μm to 3.0 μm,
a value of volume average particle diameter (dv)/number average particle diameter (dn) is 1.2 or less, and
the number of byproduct small particles per 1000 polymer microparticles each having a particle diameter of 0.1 μm or more is 500 or less.

20. A polymer microparticle obtained with the production method according to claim 13, wherein
a volume average particle diameter thereof is 0.7 μm to 3.0 μm,
a value of volume average particle diameter (dv)/number average particle diameter (dn) is 1.2 or less, and
the number of byproduct small particles per 1000 polymer microparticles each having a particle diameter of 0.1 μm or more is 500 or less.
